(19) United States
(12) Patent Application Publication
(10) Pub. No.: US 2017/0240665 A1
(43) Pub. Date: Aug. 24, 2017

(54) PROCATALYST FOR POLYMERIZATION OF OLEFINS COMPRISING A MONOESTER AND AN AMIDOBENZOATE INTERNAL DONOR

(71) Applicant: SABIC Global Technologies B.V., Berger op Zoom (NL)

(72) Inventors: Martin Alexander Zuideveld, Geleen (NL); Aurora Alexandra Batinas-Geurts, Sittard (NL); Anika Meppelder, Geleen (NL)

(21) Appl. No.: 15/314,994

(22) PCT Filed: Jun. 1, 2015
(86) PCT No.: PCT/EP2015/062118

§ 371 Date: Nov. 30, 2016

(30) Foreign Application Priority Data
Jun. 2, 2014 (EP) 14170836.2
Mar. 27, 2015 (EP) 15161420.3

(51) Int. Cl. C08F 10/06; C08F 10/02

(52) U.S. Cl. CPC C08F 10/06; C08F 10/02

(57) ABSTRACT

The present invention relates to a process for preparing a procatalyst for polymerization of olefins, comprising contacting a magnesium-containing support with a halogen-containing titanium compound, a monoester, a first internal electron donor, wherein the internal electron donor is represented by a compound represented by Formula A, for example a Fischer projection of Formula A, and optionally a second internal electron donor selected from a group consisting of diesters and diethers, Formula A said process comprising the steps of: i) contacting a butyl Grignard compound with an alkoxy- or aryloxy-containing silane compound to give a first intermediate reaction product; ii) optionally activating the first intermediate reaction product with at least one activating compound to give a second intermediate reaction product; iii) contacting the first or second intermediate reaction product, obtained respectively in step i) or ii), with a halogen-containing Ti-compound, the monoester, and said internal electron represented by a compound represented by Formula A, for example a Fischer projection of Formula A, as the first internal electron donor, and optionally the diester or di-ether as the second internal electron donor. The present invention also relates to a polymerization catalyst system comprising said procatalyst, a co-catalyst and optionally an external electron donor. Furthermore, the present invention relates to a polyolefin obtainable by the process according to the present invention and a shaped article thereof.

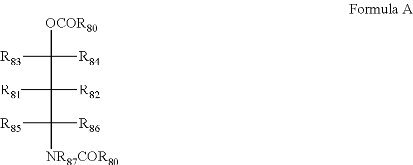

The present invention relates to a procatalyst for polymerization of olefins. The invention also relates to a process for preparing said procatalyst and to the procatalyst obtained via said process. Furthermore, the invention is directed to a catalyst system for polymerization of olefins comprising the said procatalyst, a co-catalyst and optionally an external electron donor; a process of making polyolefins by contacting at least one olefin with said catalyst system and to polyolefins obtainable by said process and a shaped article thereof. The invention also relates to the use of said procatalyst in the polymerization of olefins. Moreover, the present invention relates to polymers obtained by polymerization using said procatalyst and to the use of said polymers.

Catalyst systems and their components that are suitable for preparing a polyolefin are generally known. One type of such catalysts are generally referred to as Ziegler-Natta catalysts. The term “Ziegler-Natta” is known in the art and it typically refers to catalyst systems comprising a transition metal-containing solid catalyst compound (also typically referred to as a procatalyst); an organometallic compound (also typically referred to as a co-catalyst) and optionally one or more electron donor compounds (e.g. external electron donors).

The transition metal-containing solid catalyst compound comprises a transition metal halide (e.g. titanium halide, chromium halide, hafnium halide, zirconium halide, vanadium halide) supported on a metal or metalloid compound (e.g. a magnesium compound or a silica compound). An overview of such catalyst types is for example given by T. Pullukat and R. Hoff in Catal. Rev.—Sci. Eng. 41, vol. 3 and 4, 389-438, 1999. The preparation of such a procatalyst is for example disclosed in WO96/32427 A1.

The molecular weight distribution (MWD) influences the properties of polyolefins and as such influences the end-uses of a polymer; broad MWD generally improves the flowability at high shear rate during the processing and the processing of polyolefins in applications requiring fast processing at fairly high die swell, such as in blowing and extrusion techniques.

There is, however, an on-going need in industry for catalysts showing better performance, e.g. higher activity, good control of stereochemistry, higher isotacticity, higher hydrogen sensitivity and/or allowing obtaining polyolefins in higher yield and/or having broader molecular weight distribution.

It is thus an object of the invention to provide an improved procatalyst for polymerization of olefins, especially polypropylene, which procatalyst allows obtaining of polyolefins with broader molecular weight distribution and higher yield while maintaining good isotacticity.

One or more of the aforementioned objects of the present invention are achieved by the various aspects of the present invention.

The present invention is related to the use of an amidobenzoate internal donor combined with a monoester as activator. It has surprisingly been found by the present inventors that the combination of a monoester and amidobenzoate according to the present invention as internal donor allows the production of polymers having a broad MWD.

### SUMMARY OF THE INVENTION

The invention relates to a process for preparing a procatalyst for polymerization of olefins, comprising contacting a magnesium-containing support with a halogen-containing titanium compound, a monoester, a first internal electron donor, wherein the internal electron donor is represented by a compound represented by Formula A, for example a Fischer projection of Formula A, and optionally a second internal electron donor selected from a group consisting of diesters and diethers,

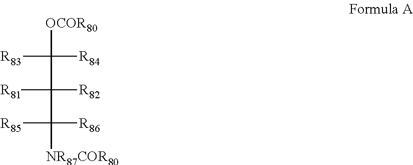

wherein in Formula A: each R⁸⁰ group is independently a substituted or unsubstituted aromatic group having from 6 to 20 carbon atoms; R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is nitrogen atom; O is oxygen atom; and C is carbon atom; said process comprising the steps of:
i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R¹ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is butyl; wherein X⁴ and X¹ are each independently selected from the group of consisting of fluoride (F−), chloride (Cl−), bromide (Br−) or iodide (I−), preferably chloride; z is in a range of larger than 0 and smaller than 2, being 0<z<2;
ii) optionally contacting the solid Mg(OR¹)ₓX¹₂₋ₓ obtained in step ii) with at least one activating compound selected from the group formed by activating electron donors and metal alkoxide compounds of formula M¹(OR²)_{v-w}(OR³)_{w} or M²(OR²)_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; v being either 3 or 4 and w is smaller than v; and preferably wherein during step ii) as activating compounds an alcohol is used as activating electron donor and titanium tetraalkoxide is used as metal alkoxide compound;
iii) contacting the first or second intermediate reaction product, obtained respectively in step i) or ii), with a halogen-containing Ti-compound, the monoester, and said internal electron represented by a compound represented by Formula A, for example a Fischer projection of Formula A, as the first internal electron donor, and optionally the diester or diether as the second internal electron donor.

In a further embodiment, R⁸¹, R⁸², R⁸³, R⁸⁴, R⁸⁵, and R⁸⁶ are independently selected from a group consisting of hydrogen, C₁-C₁₀ straight and branched alkyl; C₃-C₁₀ cycloalkyl; C₆-C₁₀ aryl; and C₇-C₁₀ alkaryl and aralkyl group, preferably wherein R⁸¹ and R⁸² is each a hydrogen atom and R⁸³, R⁸⁴, R⁸⁵, and R⁸⁶ are independently selected from a group consisting of C₁-C₁₀ straight and branched alkyl; C₃-C₁₀ cycloalkyl; C₆-C₁₀ aryl; and C₇-C₁₀ alkaryl and aralkyl group, preferably from C₁-C₁₀ straight and branched alkyl and more preferably from methyl, ethyl, propyl, isopropyl, butyl, tert-butyl, phenyl group, more preferably wherein when one of R⁸³ and R⁸⁴ and one of R⁸⁵ and R⁸⁶ has at least one carbon atom, then the other one of R⁸³ and R⁸⁴ and of R⁸⁵ and R⁸⁶ is each a hydrogen atom. In a further embodiment, R⁸⁷ is selected from a group consisting of methyl, ethyl, propyl, isopropyl, butyl, tert-butyl, phenyl, benzyl, substituted benzyl and halophenyl group. In a further embodiment, R⁸⁰ is selected from the group consisting of C₆-C₁₀ aryl; and C₇-C₁₀ alkaryl and aralkyl group; preferably, R⁸⁰ is substituted or unsubstituted phenyl, benzyl, naphthyl, ortho-tolyl, para-tolyl or anisol group, and more preferably R⁸⁰ is phenyl.

In a further embodiment, the monoester is an acetate or a benzoate, preferably ethyl acetate, amyl acetate or ethyl benzoate. In a further embodiment, the internal electron donor is selected from the group consisting of 4-[benzoyl(methyl)amino]pentan-2-yl benzoate; 2,2,6,6-tetramethyl-5-(methylamino)heptan-3-ol dibenzoate; 4-[benzoyl (ethyl)amino]pentan-2-yl benzoate and 4-(methylamino)pentan-2-yl bis (4-methoxy)benzoate). In a further embodiment, an additional or second internal electron donor is used selected from the group consisting of diesters and diethers, preferably dibutyl phthalate or 9,9-bis-methoxymethyl-fluorene, preferably wherein the molar ratio of the additional internal electron donor to magnesium is between 0.02 and 0.15. In a further embodiment, as internal donor is 4-[benzoyl(methyl)amino]pentan-2-yl benzoate is used and as monoester ethyl benzoate is used, preferably a second internal electron donor is used selected from the group consisting of diesters and diethers. In a further embodiment, as internal donor is 4-[benzoyl(methyl)amino]pentan-2-yl benzoate is used and as monoester ethyl benzoate is used and as second internal electron donor dibutyl phthalate is used. In a further embodiment, as internal donor is 4-[benzoyl(methyl)amino]pentan-2-yl benzoate is used and as monoester ethyl benzoate is used and as second internal electron donor 9,9-bis-methoxymethyl-fluorene is used.

The invention further relates to a procatalyst obtainable by the process according to the invention. The invention further relates to a polymerization catalyst system comprising the procatalyst according to the invention, a co-catalyst and optionally an external electron donor. The invention further relates to a process of making a polyolefin, preferably a polypropylene, by contacting at least one olefin with the catalyst system according to the invention. The invention further relates to a polyolefin, preferably a polypropylene, obtainable by the process according to the present invention. The invention further relates to a shaped article, comprising the polyolefin, preferably the polypropylene, according to the invention.

In a first aspect, the present invention relates to a procatalyst for polymerization of olefins, which procatalyst comprises a monoester and a compound represented by Formula A, for example a Fischer projection of Formula A, as an internal electron donor:

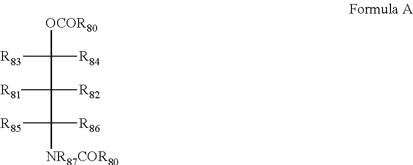

wherein each R⁸⁰ group is independently a substituted or unsubstituted aromatic group having from 6 to 20 carbon atoms; R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is nitrogen atom; O is oxygen atom; and C is carbon atom.

In an embodiment, the procatalyst comprises a monoester and a compound represented by the Fischer projection of Formula A as an internal electron donor.

In an embodiment of said first aspect, R⁸¹, R⁸², R⁸³, R⁸⁴, R⁸⁵, and R⁸⁶ are independently selected from a group consisting of hydrogen, C₁-C₁₀ straight and branched alkyl; C₃-C₁₀ cycloalkyl; C₆-C₁₀ aryl; and C₇-C₁₀ alkaryl and aralkyl group.

In a further embodiment of said first aspect, R⁸¹ and R⁸² is each a hydrogen atom and R⁸³, R⁸⁴, R⁸⁵, and R⁸⁶ are independently selected from a group consisting of C₁-C₁₀ straight and branched alkyl; C₃-C₁₀ cycloalkyl; C₆-C₁₀ aryl; and C₇-C₁₀ alkaryl and aralkyl group, preferably from C₁-C₁₀ straight and branched alkyl and more preferably from methyl, ethyl, propyl, isopropyl, butyl, tert-butyl, phenyl group.

In a further embodiment of said first aspect, when one of R⁸³ and R⁸⁴ and one of R⁸⁵ and R⁸⁶ has at least one carbon atom, then the other one of R⁸³ and R⁸⁴ and of R⁸⁵ and R⁸⁶ is each a hydrogen atom.

In a further embodiment of said first aspect, R⁸⁷ is selected from a group consisting of methyl, ethyl, propyl, isopropyl, butyl, tert-butyl, phenyl, benzyl, substituted benzyl and halophenyl group.

In a further embodiment of said first aspect, R⁸⁰ is selected from the group consisting of C₆-C₁₀ aryl; and C₇-C₁₀ alkaryl and aralkyl group; preferably, R⁸⁰ is substituted or unsubstituted phenyl, benzyl, naphthyl, ortho-tolyl, para-tolyl or anisol group, and more preferably R⁸⁰ is phenyl.

In a further embodiment of said first aspect, the first internal electron donor is selected from the group consisting of 4-[benzoyl(methyl)amino]pentan-2-yl benzoate; 2,2,6,6-tetramethyl-5-(methylamino)heptan-3-ol dibenzoate; 4-[benzoyl (ethyl)amino]pentan-2-yl benzoate and 4-(methylamino)pentan-2-yl bis (4-methoxy)benzoate), even more preferable 4-[benzoyl(methyl)amino]pentan-2-yl benzoate.

In a further embodiment, the monoester is an acetate or a benzoate, preferably ethyl acetate, amyl acetate or ethyl benzoate.

In a embodiment, the first internal donor is 4-[benzoyl(methyl)amino]pentan-2-yl benzoate and the monoester is ethyl benzoate and as a support a magnesium support prepared using a butyl Grignard is used.

In a further embodiment, the procatalyst further comprises an additional or second internal electron donor selected from the group consisting of diesters and diethers, preferably dibutyl phthalate or 9,9-bis-methoxymethyl-fluorene, preferably wherein the molar ratio of the additional internal electron donor to magnesium is between 0.02 and 0.15

In a embodiment, the first internal donor is 4-[benzoyl(methyl)amino]pentan-2-yl benzoate, the second internal donor is dibutyl phthalate and the monoester is ethyl benzoate and as a support a magnesium support prepared using a butyl Grignard is used.

In a embodiment, the first internal donor is 4-[benzoyl(methyl)amino]pentan-2-yl benzoate, the second internal donor is 9,9-bis-methoxymethyl-fluorene and the monoester is ethyl benzoate and as a support a magnesium support prepared using a butyl Grignard is used.

In a preferred embodiment, the procatalyst comprises an aminobenzoate compound represented by formula A as internal donor and ethyl benzoate as activator and is prepared using butyl Grignard, preferably n-BuMgCl, as the Grignard compound in step i) (see below).

In a preferred embodiment, the procatalyst comprises an aminobenzoate compound represented by formula A as internal donor and is prepared using butyl Grignard, preferably n-BuMgCl, as the Grignard compound in step i), wherein no monoester activator is present.

In a preferred embodiment, the procatalyst comprises an aminobenzoate compound represented by formula A as internal donor and is prepared using phenyl Grignard, preferably PhMgCl, as the Grignard compound in step i), wherein no monoester activator is present.

In a second aspect, the present invention relates to a process for preparing the procatalyst according to the present invention, comprising contacting a magnesium-containing support with a halogen-containing titanium compound, a monoester, and an internal electron donor, wherein the internal electron donor is a compound represented by Formula A, for example a Fischer projection of Formula A and optionally a second internal electron donor selected from a group consisting of diesters and diethers:

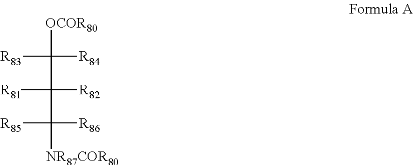

wherein:
each R⁸⁰ group is independently a substituted or unsubstituted aromatic group having from 6 to 20 carbon atoms;
R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms;
R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms;
N is nitrogen atom; O is oxygen atom; and C is carbon atom.

In an embodiment, the internal electron donor is represented by the Fischer projection of Formula A.

In an embodiment of said second aspect, said method comprises the steps of:
i) contacting a compound R⁴_{z}MgX⁴_{2-z} with an alkoxy- or aryloxy-containing silane compound to give a first intermediate reaction product, being a solid Mg(OR¹)ₓX¹₂₋ₓ, wherein: R⁴ is the same as R¹ being a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; X⁴ and X¹ are each independently selected from the group of consisting of fluoride (F−), chloride (Cl−), bromide (Br−) or iodide (I−), preferably chloride; z is in a range of larger than 0 and smaller than 2, being 0<z<2;
ii) optionally contacting the solid Mg(OR¹)ₓX¹₂₋ₓ obtained in step ii) with at least one activating compound selected from the group formed by activating electron donors and metal alkoxide compounds of formula M¹(OR²)_{v-w}(OR³)_{w} or M²(OR²)_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R² and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; v being either 3 or 4 and w is smaller than v; and
iii) contacting the first or second intermediate reaction product, obtained respectively in step i) or ii), with a halogen-containing Ti-compound, a monoester, and said internal electron represented by the compound represented by Formula A, for example a Fischer projection of Formula A, and optionally a second internal electron donor selected from the group consisting of diesters and dieters.

In a further embodiment of said second aspect, during step ii) as activating compounds an alcohol is used as activating electron donor and titanium tetraalkoxide is used as metal alkoxide compound.

In another aspect, the present invention relates to a polymerization catalyst system comprising the procatalyst according to the present invention, a co-catalyst and optionally an external electron donor.

In another aspect, the present invention relates to a process of making a polyolefin, preferably a polypropylene, by contacting at least one olefin with the catalyst system according to the present invention. In an embodiment of this aspect, propylene is used as said olefin to obtain polypropylene.

In another aspect, the present invention relates to polyolefin, preferably a polypropylene obtainable by the process of making a polyolefin according to the present invention

In another aspect, the present invention relates to shaped article, comprising the polyolefin, preferably the polypropylene according to the above aspect of the present invention.

In another aspect, the present invention relates to the use of monoester and the compound represented by Formula A, for example a Fischer projection of Formula A, as a first internal electron donor, and optionally a second internal electron donor selected from a group consisting of diesters and diethers in a procatalyst for the polymerization of at least one olefin,

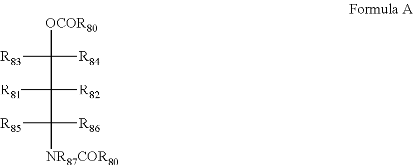

wherein: each R⁸⁰ group is independently a substituted or unsubstituted aromatic group having from 6 to 20 carbon atoms; R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof, preferably having from 1 to 20 carbon atoms; N is nitrogen atom; O is oxygen atom; and C is carbon atom. In an embodiment, the present invention relates to the use of monoester and the compound represented by the Fischer projection of Formula A as a first internal electron donor.

These aspects and embodiments will be described in more detail below.

The following definitions are used in the present description and claims to define the stated subject matter. Other terms not cited below are meant to have the generally accepted meaning in the field.

For the all aspects of the present invention, the following is observed:

“Ziegler-Natta catalyst” as used in the present description means: a transition metal-containing solid catalyst compound comprises a transition metal halide selected from titanium halide, chromium halide, hafnium halide, zirconium halide, and vanadium halide, supported on a metal or metalloid compound (e.g. a magnesium compound or a silica compound).

“Ziegler-Natta catalytic species” or “catalytic species” as used in the present description means: a transition metal-containing species comprises a transition metal halide selected from titanium halide, chromium halide, hafnium halide, zirconium halide and vanadium halide,

“internal donor” or “internal electron donor” or “ID” as used in the present description means: an electron-donating compound containing one or more atoms of oxygen (O) and/or nitrogen (N). This ID is used as a reactant in the preparation of a solid procatalyst. An internal donor is commonly described in prior art for the preparation of a solid-supported Ziegler-Natta catalyst system for olefins polymerization; i.e. by contacting a magnesium-containing support with a halogen-containing Ti compound and an internal donor.

“external donor” or “external electron donor” or “ED” as used in the present description means: an electron-donating compound used as a reactant in the polymerisation of olefins. An ED is a compound added independent of the procatalyst. It is not added during procatalyst formation. It contains at least one functional group that is capable of donating at least one pair of electrons to a metal atom. The ED may influence catalyst properties, non-limiting examples thereof are affecting the stereoselectivity of the catalyst system in polymerization of olefins having 3 or more carbon atoms, hydrogen sensitivity, ethylene sensitivity, randomness of co-monomer incorporation and catalyst productivity.

“activator” as used in the present description means: an electron-donating compound containing one or more atoms of oxygen (O) and/or nitrogen (N) which is used to during the synthesis of the procatalyst prior to or simultaneous with the addition of an internal donor.

“activating compound” as used in the present description means: a compound used to activate the solid support prior to contacting it with the catalytic species.

“modifier” or “Group 13- or transition metal modifier” as used in the present description means: a metal modifier comprising a metal selected from the metals of Group 13 of the IUPAC Periodic Table of elements and transition metals. Where in the description the terms metal modifier or metal-based modifier is used, Group 13- or transition metal modifier is meant.

“procatalyst” and “catalyst component” as used in the present description have the same meaning: a component of a catalyst composition generally comprising a solid support, a transition metal-containing catalytic species and optionally one or more internal donor.

“halide” or “halogen” as used in the present description means: an ion selected from the group of: fluoride (F−), chloride (Cl−), bromide (Br−) or iodide (I−).

“Heteroatom” as used in the present description means: an atom other than carbon or hydrogen, preferably t: F, Cl, Br, I, N, O, P, B, S or Si.

“heteroatom selected from group 13, 14, 15, 16 or 17 of the IUPAC Periodic Table of the Elements” as used in the present description means: a hetero atom selected from B, Al, Ga, In, Tl [Group 13], Si, Ge, Sn, Pb [Group 14], N, P, As, Sb, Bi [Group 15], 0, S, Se, Te, Po [Group 16], F, Cl, Br, I, At [Group 17]. More preferably, “heteroatom selected from group 13, 14, 15, 16 or 17 of the IUPAC Periodic Table of the Elements” includes N, O, P, B, S, or Si.

“hydrocarbyl” as used in the present description means: is a substituent containing hydrogen and carbon atoms, or linear, branched or cyclic saturated or unsaturated aliphatic radical, such as alkyl, alkenyl, alkadienyl and alkynyl; alicyclic radical, such as cycloalkyl, cycloalkadienyl cycloalkenyl; aromatic radical, such as monocyclic or polycyclic aromatic radical, as well as combinations thereof, such as alkaryl and aralkyl.

“substituted hydrocarbyl” as used in the present description means: is a hydrocarbyl group that is substituted with one or more non-hydrocarbyl substituent groups. A non-limiting example of a non-hydrocarbyl substituent is a heteroatom. Examples are alkoxycarbonyl (viz. carboxylate) groups. When in the present description “hydrocarbyl” is used it can also be “substituted hydrocarbyl”, unless stated otherwise.

“alkyl” as used in the present description means: an alkyl group being a functional group or side-chain consisting of carbon and hydrogen atoms having only single bonds. An alkyl group may be straight or branched and may be un-substituted or substituted.

“aryl” as used in the present description means: an aryl group being a functional group or side-chain derived from an aromatic ring. An aryl group and may be un-substituted or substituted with straight or branched hydrocarbyl groups. An aryl group also encloses alkaryl groups wherein one or more hydrogen atoms on the aromatic ring have been replaced by alkyl groups.

“aralkyl” as used in the present description means: an arylalkyl group being an alkyl group wherein one or more hydrogen atoms have been replaced by aryl groups

“alkoxide” or “alkoxy” as used in the present description means: a functional group or side-chain obtained from a alkyl alcohol. It consist of an alkyl bonded to a negatively charged oxygen atom.

“aryloxide” or “aryloxy” or “phenoxide” as used in the present description means: a functional group or side-chain obtained from an aryl alcohol. It consist of an aryl bonded to a negatively charged oxygen atom.

“Grignard reagent” or “Grignard compound” as used in the present description means: a compound or a mixture of compounds of formula R⁴_{z}MgX⁴_{2-z}(R⁴, Z, and X⁴ are as defined herein) or it may be a complex having more Mg clusters, e.g. R₄Mg₃Cl₂.

“polymer” as used in the present description means: a chemical compound comprising repeating structural units, wherein the structural units are monomers.

“olefin” as used in the present description means: an alkene.

“olefin-based polymer” or “polyolefin” as used in the present description means: a polymer of one or more alkenes.

“propylene-based polymer” as used in the present description means: a polymer of propylene and optionally a comonomer.

“polypropylene” as used in the present description means: a polymer of propylene.

“copolymer” as used in the present description means: a polymer prepared from two or more different monomers.

“monomer” as used in the present description means: a chemical compound that can undergo polymerization.

“thermoplastic” as used in the present description means: capable of softening or fusing when heated and of hardening again when cooled.

“Polymer composition” as used in the present description means: a mixture of either two or more polymers or of one or more polymers and one or more additives.

“MWD” or “Molecular weight distribution” as used in the present description means: the same as “PDI” or “polydispersity index”. It is the ratio of the weight-average molecular weight (Mw) to the number average molecular weight (Mn), viz. Mw/Mn, and is used as a measure of the broadness of molecular weight distribution of a polymer. Mw and Mn are determined by GPC using either: i) a Waters 150° C. gel permeation chromatograph combined with a Viscotek 100 differential viscosimeter; the chromatograms were run at 140° C. using 1,2,4-trichlorobenzene as a solvent; the refractive index detector was used to collect the signal for molecular weights; or ii) Polymer Laboratories PL-GPC220 combined with a Polymer Laboratories PL BV-400 viscomsimeter, and a refractive index detector, and a Polymer Char IR5 infrared detected; the chromatograms were run at 150° C. using 1,2,4-trichlorobenzene as a solvent; the refractive index detector was used to collect the signal for molecular weights. The values for both methods are the same since they both use calibration against standards.

“XS” or “xylene soluble fraction” or “CXS” or “cold soluble xylene fraction” as used in the present description means: the weight percentage (wt. %) of soluble xylene in the isolated polymer, measured according to ASTM D 5492-10.

“polymerization conditions” as used in the present description means: temperature and pressure parameters within a polymerization reactor suitable for promoting polymerization between the procatalyst and an olefin to form the desired polymer. These conditions depend on the type of polymerization used.

“production rate” or “yield” as used in the present description means: the amount of kilograms of polymer produced per gram of procatalyst consumed in the polymerization reactor per hour, unless stated otherwise.

“APP wt. %” or “weight percentage of atactic polypropylene” as used in the present description means: the fraction of polypropylene obtained in a slurry polymerization that is retained in the solvent. APP can be determined by taking 100 ml of the filtrate (“y” in millilitres) obtained during separation from polypropylene powder after slurry polymerization (“x” in grammes). The solvent is dried over a steam bath and then under vacuum at 60° C. That yields APP (“z” in grammes). The total amount of APP (“q” in grammes) is (y/100)*z. The weight percentage of APP is (q/q+x))*100%.

“MFR” or “Melt Flow rate” as used in the present description is measured at a temperature of 230° C. with 2.16 kg load and measured according to ISO 1133:2005.

Unless stated otherwise, when it is stated that any R group is “independently selected from” this means that when several of the same R groups are present in a molecule they may have the same meaning of they may not have the same meaning. For example, for the compound R₂M, wherein R is independently selected from ethyl or methyl, both R groups may be ethyl, both R groups may be methyl or one R group may be ethyl and the other R group may be methyl.

The present invention is described below in more detail. All embodiments described with respect to one aspect of the present invention are also applicable to the other aspects of the invention, unless otherwise stated.

It has been surprisingly found that the procatalyst composition that comprises a monoester and an internal electron donor compound represented by Formula A, for example a Fischer projection of Formula A, allows preparation of polyolefins, particularly of polypropylenes (PP) that have broader molecular weight distribution, higher polymer yield and good stereospecificity, i.e. high isotacticity.

Polyolefins having broad molecular weight distribution are herein polyolefins, e.g. polypropylene having a Mw/Mn higher than 6.5 or higher than 7 or even higher than 8, a broad molecular weight distribution being desirable in the development of different grades of polymer used in certain applications, such as thermoforming, pipes, foams, films, blow-molding.

The amount of amorphous atactic polymer in the products obtained (e.g. polypropylene), such as for example at most 3 wt % or at most 2 wt % or even lower than 1 wt % of the total amount of polymer, denoting high isotacticity.

The xylene solubles content of the polyolefins obtained with the procatalyst according to the present invention is also low, for instance lower than 6 wt % or lower than 5 wt %, lower than 4 wt % and or lower than 3 wt %.

The methods used in the present invention to determine the molecular weight distribution, the amount of atactic polymer, the xylene solubles content and melt flow range are described in the experimental part of the present invention.

A further advantage of the present invention is that low amount of wax is formed, i.e. low molecular weight polymers during the polymerization reaction, which results in reduced or no “stickiness” on the inside walls of the polymerization reactor and inside the reactor. In addition, the procatalyst according to the present invention can be phthalate-free and thus allows obtaining non-toxic polyolefins showing no harmful effects on human health and which thus can be used for instance in food and medical industry.

Moreover, a lower amount (2-3 times) of the compound of formula A is required when the monoester is also used compared with when only the compound of formula A and no monoester is used in the catalyst composition. Furthermore, the catalyst composition according to the present invention has higher hydrogen sensitivity (higher MFR).

In an embodiment, the procatalyst according to the invention comprises the compound represented by Formula A, for example a Fischer projection of Formula A, as the only internal electron donor.

Embodiments of the internal donor are disclosed below.

R⁸⁰ is a aromatic group, selected from aryl or alkylaryl groups and may be substituted or unsubstituted. Said aromatic group may contain one or more heteroatoms. Preferably, said aromatic group has from 6 to 20 carbon atoms. It should be noted that the two R⁸⁰ groups may be the same but may also be different.

R⁸⁰ can be the same or different than any of R⁸¹-R⁸⁷ and is preferably an aromatic substituted and unsubstituted hydrocarbyl having 6 to 10 carbon atoms.

More preferably, R⁸⁰ is selected from the group consisting of C₆-C₁₀ aryl unsubstituted or substituted with e.g. an acylhalide or an alkoxyde; and C₇-C₁₀ alkaryl and aralkyl group; for instance, 4-methoxyphenyl, 4-chlorophenyl, 4-methylphenyl.

Particularly preferred, R⁸⁰ is substituted or unsubstituted phenyl, benzyl, naphthyl, ortho-tolyl, para-tolyl or anisol group. Most preferably, R⁸⁰ is phenyl.

R⁸¹, R⁸², R⁸³, R⁸⁴, R⁸⁵, and R⁸⁶ are each independently selected from hydrogen or a hydrocarbyl group, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms.

More preferably, R⁸¹, R⁸², R⁸³, R⁸⁴, R⁸⁵, and R⁸⁶ are independently selected from a group consisting of hydrogen, C₁-C₁₀ straight and branched alkyl; C₃-C₁₀ cycloalkyl; C₆-C₁₀ aryl; and C₇-C₁₀alkaryl and aralkyl group.

Even more preferably, R⁸¹, R⁸², R⁸³, R⁸⁴, R⁸⁵, and R⁸⁶ are independently selected from a group consisting of hydrogen, methyl, ethyl, propyl, isopropyl, butyl, tert-butyl, phenyl, trifluoromethyl and halophenyl group.

Most preferably, R⁸¹, R⁸², R⁸³, R⁸⁴, R⁸⁵, and R⁸⁶ are each hydrogen, methyl, ethyl, propyl, tert-butyl, phenyl or trifluoromethyl.

Preferably, R⁸¹ and R⁸² is each a hydrogen atom.

More preferably, R⁸¹ and R⁸² is each a hydrogen atom and each of R⁸³, R⁸⁴, R⁸⁵, and R⁸⁶ is selected from the group consisting of hydrogen, C₁-C₁₀ straight and branched alkyls; C₃-C₁₀ cycloalkyls; C₆-C₁₀ aryls; and C₇-C₁₀ alkaryl and aralkyl group.

Preferably, at least one of R⁸³ and R⁸⁴ and at least one of R⁸⁵ and R⁸⁶ is a hydrocarbyl group.

More preferably, when at least one of R⁸³ and R⁸⁴ and one of R⁸⁵ and R⁸⁶ is a hydrocarbyl group having at least one carbon atom then the other one of R₃ and R₄ and of R⁸⁵ and R⁸⁶ is each a hydrogen atom.

Most preferably, when one of R⁸³ and R⁸⁴ and one of R⁸⁵ and R⁸⁶ is a hydrocarbyl group having at least one carbon atom, then the other one of R⁸³ and R⁸⁴ and of R⁸⁵ and R⁸⁶ is each a hydrogen atom and R⁸¹ and R⁸² is each a hydrogen atom.

Preferably, R⁸¹ and R⁸² is each a hydrogen atom and one of R⁸³ and R⁸⁴ and one of R⁸⁵ and R⁸⁶ is selected from the group consisting of C₁-C₁₀ straight and branched alkyl; C₃-C₁₀ cycloalkyl; C₆-C₁₀ aryl; and C₇-C₁₀ alkaryl and aralkyl group.

More preferably R⁸⁵ and R⁸⁶ is selected from the group consisting of C₁-C₁₀ alkyl, such as methyl, ethyl, propyl, isopropyl, butyl, tert-butyl, phenyl, trifluoromethyl and halophenyl group; and most preferably, one of R⁸³ and R⁸⁴, and one of R⁸⁵ and R⁸⁶ is methyl.

R⁸⁷ is a hydrocarbyl group, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 10 carbon atoms. R⁸⁷ may be the same or different than any of R⁸¹, R⁸², R⁸³, R⁸⁴, R⁸⁵, and R⁸⁶ with the provision that R⁸⁷ is not a hydrogen atom. R⁸⁷ may also be hydrogen.

More preferably, R⁸⁷ is selected from a group consisting of C₁-C₁₀ straight and branched alkyl; C₃-C₁₀cycloalkyl; C₆-C₁₀ aryl; and C₇-C₁₀ alkaryl and aralkyl group.

Even more preferably, R⁸⁷ is selected from a group consisting of methyl, ethyl, propyl, isopropyl, butyl, tert-butyl, phenyl, benzyl and substituted benzyl and halophenyl group.

Most preferably, R⁸⁷ is methyl, ethyl, propyl, isopropyl, benzyl or phenyl; and even most preferably, R⁸⁷ is methyl, ethyl or propyl.

The compound represented by Formula A, for example a Fischer projection of Formula A, can be also referred herein to as the “first internal electron donor”.

Without being limited thereto, particular examples of the compounds of Formula A are the structures as depicted in formulas B-K.

For instance, the structure in Formula A may correspond to 4-[benzoyl(methyl)amino] pentan-2-yl benzoate according to Formula B.

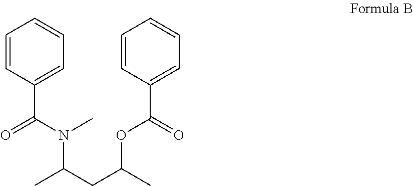 [SMILES: CC(CC(C)N(C)C(=O)c1ccccc1)OC(=O)c1ccccc1]

For instance, the structure in Formula A may correspond to 3-[benzoyl(cyclohexyl) amino]-1-phenylbutyl benzoate according to Formula C.

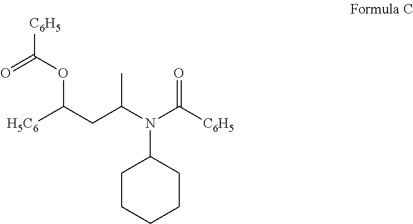

For instance, the structure in Formula A may correspond to 3-[benzoyl(propan-2-yl)amino]-1-phenylbutyl benzoate according to Formula D.

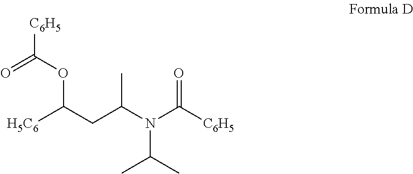

For instance, the structure in Formula A may correspond to 4-[benzoyl(propan-2-yl)amino]pentan-2-yl benzoate according to Formula E:

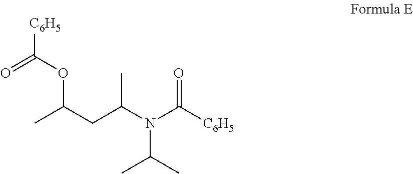

For instance, the structure in Formula A may correspond to 4-[benzoyl(methyl)amino]-1,1,1-trifluoropentan-2-yl benzoate according to Formula F:

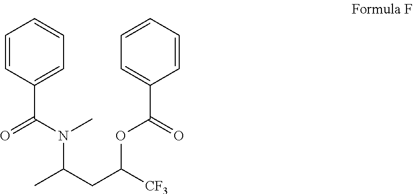 [SMILES: CC(CC(OC(=O)c1ccccc1)C(F)(F)F)N(C)C(=O)c1ccccc1]

For instance, the structure in Formula A may correspond to 3-(methylamino)-1,3-diphenylpropan-1-ol-dibenzoate according to Formula G.

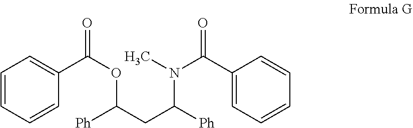 [SMILES: CN(C(=O)c1ccccc1)C(CC(OC(=O)c1ccccc1)c1ccccc1)c1ccccc1]

For instance, the structure in Formula A may correspond to 2,2,6,6-tetramethyl-5-(methylamino)heptan-3-ol dibenzoate according to Formula H:

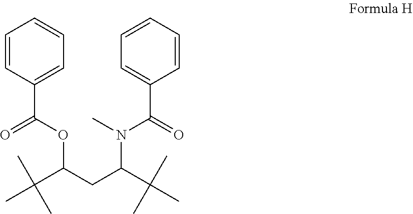 [SMILES: CN(C(=O)c1ccccc1)C(CC(OC(=O)c1ccccc1)C(C)(C)C)C(C)(C)C]

For instance, the structure in Formula A may correspond to 4-[benzoyl (ethyl)amino]pentan-2-yl benzoate according to Formula J:

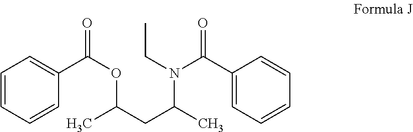 [SMILES: CCN(C(=O)c1ccccc1)C(C)CC(C)OC(=O)c1ccccc1]

For instance, the structure in Formula A may correspond to 4-(methylamino)pentan-2-yl bis (4-methoxy)benzoate according to Formula K:

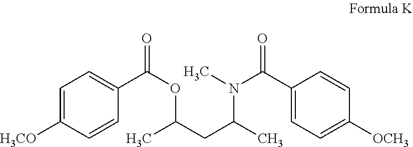 [SMILES: COc1ccc(C(=O)OC(C)CC(C)N(C)C(=O)c2ccc(OC)cc2)cc1]

For instance, the structure in Formula A may correspond to 3-(methyl)amino-propan-1-ol dibenzoate according to Formula L

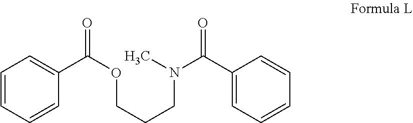 [SMILES: CN(CCCOC(=O)c1ccccc1)C(=O)c1ccccc1]

For instance, the structure in Formula A may correspond to 3-(methyl)amino-2,2-dimethylpropan-1-ol dibenzoate according to Formula M

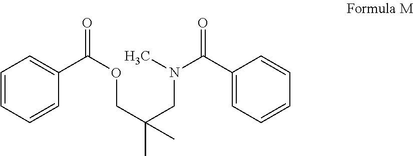 [SMILES: CN(CC(C)(C)COC(=O)c1ccccc1)C(=O)c1ccccc1]

The compounds of Formula B, J, K, and G are the most preferred internal electron donors in the procatalyst according to the present invention as they allow preparation of polyolefins having narrow molecular weight distribution and/or higher external donor sensitivity and/or higher hydrogen sensitivity.

The compound of formula B is one of the preferred first internal electron donors in the catalyst composition according to the present invention as it has high catalytic activity and it allows preparation of polyolefins having molecular weight distribution broader than 7, high isotacticity and with high yield.

Mono-esters are used as activators in the present invention. The monoester according to the present invention can be any ester of a monocarboxylic acid known in the art. The structures according to Formula V and Formula XXIII are suitable as monoesters, but the invention is not limited thereto.

R⁹⁴—CO—OR⁹⁵ Formula XXIII

R⁹⁴ and R⁹⁵ are each independently selected from a hydrogen or a hydrocarbyl group selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably 1 to 10 carbon atoms, even more preferably from 1 to 8 carbon atoms, even more preferably from 1 to 6 carbon atoms. When R⁹⁴ is an aryl, this structure is similar to Formula V. Examples of aromatic mono-esters are discussed with reference to formula V.

Suitable examples of mono-esters according to formula XXII include formates, for instance, butyl formate; acetates, for instance ethyl acetate, amyl acetate and butyl acetate; acrylates, for instance ethyl acrylate, methyl methacrylate and isobutyl methacrylate. More preferably, the aliphatic monoester is an acetate. Most preferably, the aliphatic monoester is ethyl acetate.

As monoester according to the present invention, a benzoic acid ester can be used according to Formula V.

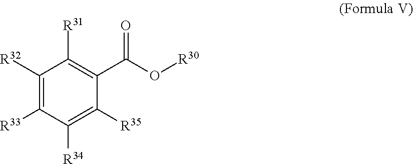

R³⁰ is selected from a hydrocarbyl group independently selected from alkyl, alkenyl, aryl, aralkyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 10 carbon atoms, more preferably from 1 to 8 carbon atoms, even more preferably from 1 to 6 carbon atoms. Suitable examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

R³¹, R³², R³³, R³⁴, R³⁵ are each independently selected from hydrogen, a heteroatom (preferably a halide), or a hydrocarbyl group, selected from e.g. alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 10 carbon atoms, more preferably from 1 to 8 carbon atoms, even more preferably from 1 to 6 carbon atoms.

Suitable non-limiting examples of “benzoic acid esters” include C₁-C₂₀ hydrocarbyl esters of benzoic acid, such as an alkyl p-alkoxybenzoate (such as ethyl p-methoxy benzoate, methyl p-ethoxybenzoate, ethyl p-ethoxybenzoate), an alkyl benzoate (such as ethyl benzoate, methyl benzoate, propyl benzoate), an alkyl p-halobenzoate (ethyl p-chlorobenzoate, ethyl p-bromobenzoate), and benzoic anhydride. Other suitable examples include methyl-p-toluate and ethyl-naphthate. The benzoic acid ester is preferably selected from ethyl benzoate, benzoyl chloride, ethyl p-bromobenzoate, n-propyl benzoate and benzoic anhydride. The benzoic acid ester is more preferably ethyl benzoate.

Most preferably, the monoester is ethyl acetate, amyl acetate or ethyl benzoate.

In an embodiment, the monoester used in step iii) is an ester of an aliphatic monocarboxylic acid having from 1 to 10 carbon atoms. Wherein R⁹⁴ is an aliphatic hydrocarbyl group.

The molar ratio between the monoester in step iii) and Mg may range from 0.05 to 0.5, preferably from 0.1 to 0.4, and most preferably from 0.15 to 0.25.

The monoester is not used as a stereospecificity agent, like usual internal donors are known to be in the prior art. The monoester is used as an activator.

Without to be bound by any theory, the inventors believe that the monoester used in the process according to the present invention participates at the formation of the magnesium halogen (e.g. MgCl₂) crystallites during the interaction of Mg-containing support with titanium halogen (e.g. TiCl₄). The monoester may form intermediate complexes with Ti and Mg halogen compounds (for instance, TiCl₄, TiCl₃(OR), MgCl₂, MgCl(OEt), etc.), help to the removal of titanium products from solid particles to mother liquor and affect the activity of final catalyst. Therefore, the monoester according to the present invention can also be referred to as an activator.

The catalyst composition according to the present invention may further comprise an additional internal electron donor, herein also referred to as the “second internal electron donor”. The additional internal donor is selected from a group consisting of diesters and diethers.

The diester can be any ester of a C6-C20 aromatic dicarboxylic acid or a C1-C20 aliphatic dicarboxylic acid known in the art. Suitable examples of diesters include C6-C20 aromatic or C1-C20 aliphatic substituted phthalates, e.g. dibutyl phthalate, diisobutyl phthalate, diallyl phthalate and/or diphenyl phthalate; C6-C20 aromatic or C1-C20 aliphatic substituted succinates; and also C6-C20 aromatic or C1-C20 aliphatic substituted esters of malonic acid or glutaric acid. Preferably the diester is a C1-C10 aliphatic substituted phthalate, more preferably dibutyl phthalate.

As used herein a “di-ether” may be a 1,3-di(hydrocarboxy)propane compound, optionally substituted on the 2-position represented by the Formula VII,

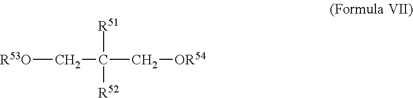

R⁵¹ and R⁵² are each independently selected from a hydrogen or a hydrocarbyl group selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 10 carbon atoms, more preferably from 1 to 8 carbon atoms, even more preferably from 1 to 6 carbon atoms. Suitable examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

R⁵³ and R⁵⁴ are each independently selected from hydrogen, a halide or a hydrocarbyl group, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 10 carbon atoms, more preferably from 1 to 8 carbon atoms, even more preferably from 1 to 6 carbon atoms.

Suitable examples of dialkyl diether compounds include 1,3-dimethoxypropane, 1,3-diethoxypropane, 1,3-dibutoxypropane, 1-methoxy-3-ethoxypropane, 1-methoxy-3-butoxypropane, 1-methoxy-3-cyclohexoxypropane, 2,2-dimethyl-1,3-dimethoxypropane, 2,2-diethyl-1,3-dimethoxypropane, 2,2-di-n-butyl-1,3-dimethoxypropane, 2,2-diiso-butyl-1,3-dimethoxypropane, 2-ethyl-2-n-butyl-1,3-dimethoxypropane, 2-n-propyl-2-cyclopentyl-1,3-dimethoxypropane, 2,2-dimethyl-1,3-diethoxypropane, 2-n-propyl-2-cyclohexyl-1,3-diethoxypropane, 2-(2-ethylhexyl)-1,3-dimethoxypropane, 2-isopropyl-1,3-dimethoxypropane, 2-n-butyl-1,3-dimethoxypropane, 2-sec-butyl-1,3-dimethoxypropane, 2-cyclohexyl-1,3-dimethoxypropane, 2-phenyl-1,3-diethoxypropane, 2-cumyl-1,3-diethoxypropane, 2-(2-phenyllethyl)-1,3-dimethoxypropane, 2-(2-cyclohexylethyl)-1,3-dimethoxypropane, 2-(p-chlorophenyl)-1,3-dimethoxypropane, 2-(diphenyl-methyl)-1,3-dimethoxypropane, 2-(1-naphthyl)-1,3-dimethoxypropane, 2-(fluorophenyl)-1,3-dimethoxypropane, 2-(1-decahydronaphthyl)-1,3-dimethoxypropane, 2-(p-t-butylphenyl)-1,3-dimethoxypropane, 2,2-dicyclohexyl-1,3-dimethoxypropane, 2,2-di-npropyl-1,3-dimethoxypropane, 2-methyl-2-n-propyl-1,3-dimethoxypropane, 2-methyl-2-benzyl-1,3-dimethoxypropane, 2-methyl-2-ethyl-1,3-dimethoxypropane, 2-methyl-2-phenyl-1,3-dimethoxypropane, 2-methyl-2-cyclohexyl-1,3-dimethoxypropane, 2,2-bis(pchlorophenyl)-1,3-dimethoxypropane, 2,2-bis(2-cyclohexylethyl)-1,3-dimethoxypropane, 2-methyl-2-iso butyl-1,3-dimethoxypropane, 2-methyl-2-(2-ethylhexyl)-1,3-dimethoxy propane, 2-methyl-2-isopropyl-1,3-dimethoxypropane, 2,2-diphenyl-1,3-dimethoxypropane, 2,2-dibenzyl-1,3-dimethoxypropane, 2,2-bis(cyclohexylmethyl)-1,3-dimethoxypropane, 2,2-diiso butyl-1,3-diethoxypropane, 2,2-diisobuty 1-1,3-di-n-butoxypropane, 2-iso butyl-2-isopropyl-1,3-dimethoxypropane, 2,2-di-sec-butyl-1,3-dimethoxypropane, 2,2-di-t-butyl-1,3-dimethoxypropane, 2,2-dineopentyl-1,3-dimethoxypropane, 2-isopropyl-2-isopentyl-1,3-dimethoxypropane, 2-phenyl-2-benzyl-1,3-dimethoxypropane, 2-cyclohexyl-2-cyclohexylmethyl-1,3-dimethoxypropane, 2-isopropyl-2-(3, 7-dimethyloctyl) 1,3-dimethoxypropane, 2,2-diisopropyl-1,3-dimethoxypropane, 2-isopropyl-2-cyclohexylmethyl-1,3-dimethoxypropane, 2,2-diisopentyl-1,3-dimethoxypropane, 2-isopropyl-2-cyclohexyl-1,3-dimethoxypropane, 2-isopropyl-2-cyclopentyl-1,3-dimethoxypropane, 2,2-dicylopentyl-1,3-dimethoxypropane, 2-n-heptyl-2-n-pentyl-1,3-dimethoxypropane, 9,9-bis(methoxymethyl)fluorene, 1,3-dicyclohexyl-2,2-bis(methoxymethyl)propane, 3,3-bis(methoxymethyl)-2,5-dimethylhexane, or any combination of the foregoing. In an embodiment, the internal electron donor is 1,3-dicyclohexyl-2,2-bis(methoxymethyl)propane, 3,3-bis(methoxymethyl)-2,5-dimethylhexane, 2,2-dicyclopentyl-1,3-dimethoxypropane and combinations thereof.

Examples of preferred ethers are diethyl ethers, such as 2-ethyl-2-butyl-1,3-dimethoxypropane, 2-isopropyl-2-isopentyl-1,3-dimethoxypropane and 9,9-bis (methoxymethyl) fluorene:

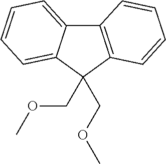 [SMILES: COCC1(COC)c2ccccc2-c2ccccc21]

The compound according to Formula A can be made by any method known in the art. In this respect, reference is made to J. Chem. Soc. Perkin trans. I 1994, 537-543 and to Org. Synth. 1967, 47, 44. These documents disclose a step a) of contacting a substituted 2,4-diketone with a substituted amine in the presence of a solvent to give a beta-enaminoketone; followed by a step b) of contacting the beta-enaminoketone with a reducing agent in the presence of a solvent to give a gamma-aminoalcohol. The substituted 2,4-diketone and the substituted amine can be applied in step a) in amounts ranging from 0.5 to 2.0 mole, preferably from 1.0 to 1.2 mole. The solvent in steps a) and b) may be added in an amount of 5 to 15 volume, based on the total amount of the diketone, preferably of 3 to 6 volume. The beta-enaminoketone to diketone mole ratio in step b) may be of from 0.5 to 6, preferably from 1 to 3. The reducing agent to beta-enaminoketone mole ratio in step b) may be of from 3 to 8, preferably from 4 to 6; the reducing agent may be selected from the group comprising metallic sodium, NaBH₄ in acetic acid, Ni—Al alloy. Preferably, the reducing agent is metallic sodium because it is a cheap reagent.

The gamma-aminoalcohol that can be used for making a compound represented by Formula A, for example a Fischer projection of Formula A, can be synthesized as described in the literature and also mentioned herein or this compound can be directly purchased commercially and used as a starting compound in a reaction to obtain the compound represented by Formula A. Particularly, the gamma-aminoalcohol can be reacted with a substituted or unsubstituted benzoyl chloride in the presence of a base to obtain the compound represented by Formula A (referred herein also as step c), regardless that gamma-aminoalcohol was synthesized as described in the literature or commercially purchased). The molar ratio between the substituted or unsubstituted benzoyl chloride and the gamma-aminoalcohol may range from 2 to 4, preferably from 2 to 3. The base may be any basic chemical compound that is able to deprotonate the gamma-aminoalcohol. Said base can have a pKₐ of at least 5; or at least 10 or preferably from 5 to 40, wherein pKₐ is a constant already known to the skilled person as the negative logarithm of the acid dissociation constant kₐ. Preferably, the base is pyridine; a trialkyl amine, e.g. triethylamine; or a metal hydroxide e.g. NaOH, KOH. Preferably, the base is pyridine. The molar ratio between the base and the gamma-aminoalcohol may range from 3 to 10, preferably from 4 to 6.

The solvent used in any of steps a), b) and c) can be selected from any organic solvents, such as toluene, dichloromethane, 2-propanol, cyclohexane or mixtures of any organic solvents. Preferably, toluene is used in each of steps a), b) and c). More preferably, a mixture of toluene and 2-propanol is used in step b). The solvent in step c) can be added in an amount of 3 to 15 volume, preferably from 5 to 10 volume based on the gamma-aminoalcohol.

The reaction mixture in any of steps a), b) and c) may be stirred by using any type of conventional agitators for more than about 1 hour, preferably for more than about 3 hours and most preferably for more than about 10 hours, but less than about 24 hours. The reaction temperature in any of steps a) and b) may be the room temperature, i.e. of from about 15 to about 30° C., preferably of from about 20 to about 25° C. The reaction temperature in step c) may range from 0 to 10° C., preferably from 5 to 10° C. The reaction mixture in any of steps a), b) and c) may be refluxed for more than about 10 hours, preferably for more than about 20 hours but less than about 40 hours or until the reaction is complete (reaction completion may be measured by Gas Chromatography, GC). The reaction mixture of steps a) and b) may be then allowed to cool to room temperature, i.e. at a temperature of from about 15 to about 30° C., preferably of from about 20 to about 25° C. The solvent and any excess of components may be removed in any of steps a), b) and c) by any method known in the art, such as evaporation, washing. The obtained product in any of steps b) and c) can be separated from the reaction mixture by any method known in the art, such as by extraction over metal salts, e.g. sodium sulphate.

The molar ratio of the internal donor compound represented by Formula A, for example a Fischer projection of Formula A, relative to the magnesium can be from 0.02 to 0.5. Preferably, this molar ratio is from 0.05 to 0.2.

The process for preparing the procatalyst according to the present invention comprises contacting a magnesium-containing support with a halogen-containing titanium compound, a monoester and an internal donor, wherein the internal electron donor is the compound represented by Formula A, for example a Fischer projection of Formula A.

The present invention is related to Ziegler-Natta type catalyst. A Ziegler-Natta type procatalyst generally comprising a solid support, a transition metal-containing catalytic species and an internal donor. The present invention moreover relates to a catalyst system comprising a Ziegler-Natta type procatalyst, a co-catalyst and optionally an external electron donor. The term “Ziegler-Natta” is known in the art.

The transition metal-containing solid catalyst compound comprises a transition metal halide (e.g. titanium halide, chromium halide, hafnium halide, zirconium halide, vanadium halide) supported on a metal or metalloid compound (e.g. a magnesium compound or a silica compound).

Specific examples of several types of Ziegler-Natta catalyst as disclosed below.

Preferably, the present invention is related to a so-called TiNo catalyst. It is a magnesium-based supported titanium halide catalyst comprising an internal donor.

The magnesium-containing support and halogen-containing titanium compounds used in the process according to the present invention are known in the art as typical components of a Ziegler-Natta procatalyst. Any of said Ziegler-Natta procatalysts known in the art can be used in the process according to the present invention. For instance, synthesis of such titanium-magnesium based procatalysts with different magnesium-containing support-precursors, such as magnesium halides, magnesium alkyls and magnesium aryls, and also magnesium alkoxy and magnesium aryloxy compounds for polyolefin production, particularly of polypropylenes production are described for instance in U.S. Pat. No. 4,978,648, WO96/32427A1, WO01/23441 Al, EP1283222A1, EP1222 214B1; U.S. Pat. No. 5,077,357; U.S. Pat. No. 5,556,820; U.S. Pat. No. 4,414,132; U.S. Pat. No. 5,106,806 and U.S. Pat. No. 5,077,357 but the present process is not limited to the disclosure in these documents.

EP 1 273 595 of Borealis Technology discloses a process for producing an olefin polymerisation procatalyst in the form of particles having a predetermined size range, said process comprising: preparing a solution a complex of a group IIa metal and an electron donor by reacting a compound of said metal with said electron donor or a precursor thereof in an organic liquid reaction medium; reacting said complex, in solution, with at least one compound of a transition metal to produce an emulsion the dispersed phase of which contains more than 50 mol % of the group IIa metal in said complex; maintaining the particles of said dispersed phase within the average size range 10 to 200 micrometer by agitation in the presence of an emulsion stabilizer and solidifying said particles; and recovering, washing and drying said particles to obtain said procatalyst.

EP 0 019 330 of Dow discloses a Ziegler-Natta type catalyst composition. Said olefin polymerization catalyst composition comprising: a) a reaction product of an organo aluminium compound and an electron donor, and b) a solid component which has been obtained by halogenating a magnesium compound with the formula MgR¹R² wherein R¹ is an alkyl, aryl, alkoxide or aryloxide group and R² is an alkyl, aryl, alkoxide or aryloxide group or halogen, with a halide of tetravalent titanium in the presence of a halohydrocarbon, and contacting the halogenated product with a tetravalent titanium compound.

The procatalyst may be produced by any method known in the art using the present internal electron donor.

The procatalyst may also be produced as disclosed in WO96/32426A; this document discloses a process for the polymerization of propylene using a catalyst comprising a procatalyst obtained by a process wherein a compound with formula Mg(OAlk)ₓCl_{y} wherein x is larger than 0 and smaller than 2, y equals 2−x and each Alk, independently, represents an alkyl group, is contacted with a titanium tetraalkoxide and/or an alcohol in the presence of an inert dispersant to give an intermediate reaction product and wherein the intermediate reaction product is contacted with titanium tetrachloride in the presence of an internal donor, which is di-n-butyl phthalate.

Preferably, the Ziegler-Natta type procatalyst in the catalyst system according to the present invention is obtained by the process as described in WO 2007/134851 A1. In Example I the process is disclosed in more detail. Example I including all sub-examples (IA-IE) is incorporated into the present description. More details about the different embodiments are disclosed starting on page 3, line 29 to page 14 line 29. These embodiments are incorporated by reference into the present description.

In the following part of the description the different steps and phases of the process for preparing the procatalyst according to the present invention will be discussed.

The process for preparing a procatalyst according to the present invention comprises the following phases:
Phase A): preparing a solid support for the procatalyst;
Phase B): optionally activating said solid support obtained in phase A) using one or more activating compounds to obtain an activated solid support;
Phase C): contacting said solid support obtained in phase A) or said activated solid support in phase B) with a catalytic species wherein phase C) comprises one of the following:
   i. contacting said solid support obtained in phase A) or said activated solid support in phase B) with a catalytic species, an activator, and one or more internal donors to obtain said procatalyst; or
   ii. contacting said solid support obtained in phase A) or said activated solid support in phase B) with a catalytic species, an activator, and one or more internal donors to obtain an intermediate product; or
   iii. contacting said solid support obtained in phase A) or said activated solid support in phase B) with a catalytic species and an activator to obtain an intermediate product;
optionally Phase D: modifying said intermediate product obtained in phase C) wherein phase D) comprises on of the following:
   i. modifying said intermediate product obtained in phase C) with a Group 13- or transition metal modifier in case an internal donor was used during phase C), in order to obtain a procatalyst;
   ii. modifying said intermediate product obtained in phase C) with a Group 13- or transition metal modifier and an internal donor in case an activator was used during phase C), in order to obtain a procatalyst.

The procatalyst thus prepared can be used in polymerization of olefins using an external donor and a co-catalyst.

It is thus noted that the process according to the present invention is different from the prior art process by the use of a different internal donor.

The various steps used to prepare the catalyst according to the present invention (and the prior art) are described in more detail below.

### Phase A: Preparing a Solid Support for the Catalyst.

In the process of the present invention preferably a magnesium-containing support is used. Said magnesium-containing support is known in the art as a typical component of a Ziegler-Natta procatalyst. This step of preparing a solid support for the catalyst is the same as in the prior art process. The following description explains the process of preparing magnesium-based support. Other supports may be used.

Synthesis of magnesium-containing supports, such as magnesium halides, magnesium alkyls and magnesium aryls, and also magnesium alkoxy and magnesium aryloxy compounds for polyolefin production, particularly of polypropylenes production are described for instance in U.S. Pat. No. 4,978,648, WO96/32427A1, WO01/23441 A1, EP1283 222A1, EP1222 214B1; U.S. Pat. No. 5,077,357; U.S. Pat. No. 5,556,820; U.S. Pat. No. 4,414,132; U.S. Pat. No. 5,106,806 and U.S. Pat. No. 5,077,357 but the present process is not limited to the disclosure in these documents.

Preferably, the process for preparing the solid support for the procatalyst according to the present invention comprises the following steps: step o) which is optional and step i). Step o) preparation of the Grignard reagent (optional) and Step i) reacting a Grignard compound with a silane compound.

### Step o) Preparation of the Grignard Reagent (Optional).

A Grignard reagent, R⁴zMgX⁴_{2-z} used in step i) may be prepared by contacting metallic magnesium with an organic halide R⁴X⁴, as described in WO 96/32427 A1 and WO01/23441 A1. All forms of metallic magnesium may be used, but preferably use is made of finely divided metallic magnesium, for example magnesium powder. To obtain a fast reaction it is preferable to heat the magnesium under nitrogen prior to use.

R⁴ is a hydrocarbyl group independently selected from alkyl, alkenyl, aryl, aralkyl, alkylaryl, or alkoxycarbonyl groups, wherein said hydrocarbyl group may be linear, branched or cyclic, and may be substituted or unsubstituted; said hydrocarbyl group preferably having from 1 to 20 carbon atoms or combinations thereof, most preferably it is butyl. The R⁴ group may contain one or more heteroatoms.

X⁴ is selected from the group of consisting of fluoride (F−), chloride (Cl−), bromide (Br−) or iodide (I−). The value for z is in a range of larger than 0 and smaller than 2: 0<z<2 Combinations of two or more organic halides R⁴X⁴ can also be used.

The magnesium and the organic halide R⁴X⁴ can be reacted with each other without the use of a separate dispersant; the organic halide R⁴X⁴ is then used in excess.

The organic halide R⁴X⁴ and the magnesium can also be brought into contact with one another and an inert dispersant. Examples of these dispersants are: aliphatic, alicyclic or aromatic dispersants containing from 4 up to 20 carbon atoms.

Preferably, in this step o) of preparing R⁴_{z}MgX⁴_{2-z}, also an ether is added to the reaction mixture.

Examples of ethers are: diethyl ether, diisopropyl ether, dibutyl ether, diisobutyl ether, diisoamyl ether, diallyl ether, tetrahydrofuran and anisole. Dibutyl ether and/or diisoamyl ether are preferably used. Preferably, an excess of chlorobenzene is used as the organic halide R⁴X⁴. Thus, the chlorobenzene serves as dispersant as well as organic halide R⁴X⁴.

The organic halide/ether ratio acts upon the activity of the procatalyst. The chlorobenzene/dibutyl ether volume ratio may for example vary from 75:25 to 35:65, preferably from 70:30 to 50:50.

Small amounts of iodine and/or alkyl halides can be added to cause the reaction between the metallic magnesium and the organic halide R⁴X⁴ to proceed at a higher rate. Examples of alkyl halides are butyl chloride, butyl bromide and 1,2-dibromoethane. When the organic halide R⁴X⁴ is an alkyl halide, iodine and 1,2-dibromoethane are preferably used.

The reaction temperature for step o) of preparing R⁴_{z}MgX⁴_{2-z} normally is from 20 to 150° C.; the reaction time is normally from 0.5 to 20 hours. After the reaction for preparing R⁴_{z}MgX⁴_{2-z} is completed, the dissolved reaction product may be separated from the solid residual products.

The reaction may be mixed. The stirring speed can be determined by a person skilled in the art and should be sufficient to agitate the reactants.

Step i) Reacting a Grignard Compound with a Silane Compound.

Step i): contacting a compound R⁴_{z}MgX⁴_{2-z}—wherein R₄, X⁴, and z are as discussed herein—with an alkoxy- or aryloxy-containing silane compound to give a first intermediate reaction product. Said first intermediate reaction product is a solid magnesium-containing support.

In step i) a first intermediate reaction product is thus prepared by contacting the following reactants: * a Grignard reagent—being a compound or a mixture of compounds of formula R⁴_{z}MgX⁴_{2-z} and * an alkoxy- or aryloxy-containing silane compound. Examples of these reactants are disclosed for example in WO 96/32427 Al and WO01/23441 A1.

The compound R⁴_{z}MgX⁴_{2-z} used as starting product is also referred to as a Grignard compound. In R⁴_{z}MgX⁴_{2-z}, X⁴ is preferably chlorine or bromine, more preferably chlorine.

R⁴ can be an alkyl, aryl, aralkyl, alkoxide, phenoxide, etc., or mixtures thereof. Suitable examples of group R⁴ are methyl, ethyl, n-propyl, i-propyl, n-butyl, i-butyl, t-butyl, hexyl, cyclohexyl, octyl, phenyl, tolyl, xylyl, mesityl, benzyl, phenyl, naphthyl, thienyl, indolyl. In a preferred embodiment of the invention, R⁴ represents an aliphatic group, for instance a butyl group.

Preferably, as Grignard compound R⁴_{z}MgX⁴_{2-z} used in step i) a phenyl grignard or a butyl Grignard is used. The selection for either the phenyl Grignard or the butyl Grignard depends on the requirements.

When Grignard compound is used, a compound according to the formula R⁴_{z}MgX⁴_{2-z} is meant. When phenyl Grignard is used a compound according to the formula R⁴_{z}MgX⁴_{2-z} wherein R⁴ is phenyl, e.g. PhMgCl, is meant. When butyl Grignard is used, a compound according to the formula R⁴_{z}MgX⁴_{2-z} wherein R⁴ is butyl, e.g. BuMgCl or n-BuMgCl, is meant.

An advantage of the use of phenyl Grignard are that it is more active that butyl Grignard. Preferably, when butyl Grignard is used, an activation step using an aliphatic alcohol, such as methanol is carried out in order to increase the activity. Such an activation step may not be required with the use of phenyl Grignard. A disadvantage of the use of phenyl Grignard is that benzene rest products may be present and that it is more expensive and hence commercially less interesting.

An advantage of the use of butyl Grignard is that it is benzene free and is commercially more interesting due to the lower price. A disadvantage of the use of butyl Grignard is that in order to have a high activity, an activation step is required.

The process to prepare the procatalyst according to the present invention can be carried out using any Grignard compound, but the two stated above are the two that are most preferred.

In the Grignard compound of formula R⁴_{z}MgX⁴_{2-z} is preferably from about 0.5 to 1.5.

The compound R⁴_{z}MgX⁴_{2-z} may be prepared in an optional step (step o) which is discussed herein), preceding step i) or may be obtained from a different process.

It is explicitly noted that it is possible that the Grignard compound used in step i) may alternatively have a different structure, for example, may be a complex. Such complexes are already known to the skilled person in the art.

The alkoxy- or aryloxy-containing silane used in step i) is preferably a compound or a mixture of compounds with the general formula Si(OR⁵)₄₋ₙR⁶ₙ, wherein: It should be noted that the R⁵ group is the same as the R¹ group. The R¹ group originates from the R⁵ group during the synthesis of the first intermediate reaction product.

R⁵ is a hydrocarbyl group independently selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. Preferably, said hydrocarbyl group is an alkyl group, preferably having from 1 to 20 carbon atoms, more preferably from 1 to 12 carbon atoms, even more preferably from 1 to 6 carbon atoms, such as for example methyl, ethyl, n-propyl, isopropyl, n-butyl, sec-butyl, iso-butyl, tert-butyl, pentyl or hexyl; most preferably, selected from ethyl and methyl.

R⁶ is a hydrocarbyl group independently selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. Preferably, said hydrocarbyl group is an alkyl group, preferably having from 1 to 20 carbon atoms, more preferably from 1 to 12 carbon atoms, even more preferably from 1 to 6 carbon atoms, such as for example methyl, ethyl, n-propyl, isopropyl, n-butyl, sec-butyl, iso-butyl, tert-butyl, or cyclopentyl.

The value for n is in the range of 0 up to 3, preferably n is from 0 up to and including 1.

Examples of suitable silane-compounds include tetramethoxysilane, tetraethoxysilane, methyltrimethoxysilane, methyltributoxysilane, phenyltriethoxy-silane, diethyldiphenoxysilane, n-propyltriethoxysilane, diisopropyldi-methoxysilane, diisobutyldimethoxysilane, n-propyltrimethoxysilane, cyclohexyl-methyldimethoxysilane, dicyclopentyldimethoxy-silane, isobutylisopropyldimethoxyl-silane, phenyl-trimethoxysilane, diphenyl-dimethoxysilane, trifluoropropylmethyl-dimethoxysilane, bis(perhydroisoquinolino)-dimethoxysilane, dicyclohexyldimethoxy-silane, dinorbornyl-dimethoxysilane, di(n-propyl)dimethoxysilane, di(iso-propyl)-dimethoxysilane, di(n-butyl)dimethoxysilane and/or di(iso-butyl)dimethoxysilane.

Preferably, tetraethoxy-silane is used as silane-compound in preparing the solid Mg-containing compound during step i) in the process according to the present invention.

Preferably, in step i) the silane-compound and the Grignard compound are introduced simultaneously to a mixing device to result in particles of the first intermediate reaction product having advantageous morphology. This is for example described in WO 01/23441 A1. Here, ‘morphology’ does not only refer to the shape of the particles of the solid Mg-compound and the catalyst made therefrom, but also to the particle size distribution (also characterized as span), its fines content, powder flowability, and the bulk density of the catalyst particles. Moreover, it is well known that a polyolefin powder produced in polymerization process using a catalyst system based on such procatalyst has a similar morphology as the procatalyst (the so-called “replica effect”; see for instance S. van der Ven, Polypropylene and other Polyolefins, Elsevier 1990, p. 8-10). Accordingly, almost round polymer particles are obtained with a length/diameter ratio (I/D) smaller than 2 and with good powder flowability.

As discussed above, the reactants are preferably introduced simultaneously. With “introduced simultaneously” is meant that the introduction of the Grignard compound and the silane-compound is done in such way that the molar ratio Mg/Si does not substantially vary during the introduction of these compounds to the mixing device, as described in WO 01/23441 A1.

The silane-compound and Grignard compound can be continuously or batch-wise introduced to the mixing device. Preferably, both compounds are introduced continuously to a mixing device.

The mixing device can have various forms; it can be a mixing device in which the silane-compound is premixed with the Grignard compound, the mixing device can also be a stirred reactor, in which the reaction between the compounds takes place. The separate components may be dosed to the mixing device by means of peristaltic pumps.

Preferably, the compounds are premixed before the mixture is introduced to the reactor for step i). In this way, a procatalyst is formed with a morphology that leads to polymer particles with the best morphology (high bulk density, narrow particle size distribution, (virtually) no fines, excellent flowability).

The Si/Mg molar ratio during step i) may range from 0.2 to 20. Preferably, the Si/Mg molar ratio is from 0.4 to 1.0.

The period of premixing of the reactants in above indicated reaction step may vary between wide limits, for instance 0.1 to 300 seconds. Preferably premixing is performed during 1 to 50 seconds.

The temperature during the premixing step of the reactants is not specifically critical, and may for instance range from 0 to 80° C.; preferably the temperature is from 10° C. to 50° C.

The reaction between said reactants may, for instance, take place at a temperature from −20° C. to 100° C.; for example at a temperature of from 0° C. to 80° C. The reaction time is for example from 1 to 5 hours.

The mixing speed during the reaction depends on the type of reactor used and the scale of the reactor used. The mixing speed can be determined by a person skilled in the art. As a non-limiting example, mixing may be carried out at a mixing speed of from 250 to 300 rpm. In an embodiment, when a blade stirrer is used the mixing speed is from 220 to 280 rpm and when a propeller stirrer is used the mixing speed is from 270 to 330 rpm. The stirrer speed may be increased during the reaction. For example, during the dosing, the speed of stirring may be increased every hour by 20-30 rpm.

Preferably BuMgCl is the Grignard agent used in step i).

The first intermediate reaction product obtained from the reaction between the silane compound and the Grignard compound is usually purified by decanting or filtration followed by rinsing with an inert solvent, for instance a hydrocarbon solvent with for example 1-20 carbon atoms, like pentane, iso-pentane, hexane or heptane. The solid product can be stored and further used as a suspension in said inert solvent. Alternatively, the product may be dried, preferably partly dried, and preferably under mild conditions; e.g. at ambient temperature and pressure.

The first intermediate reaction product obtained by this step i) may comprise a compound of the formula Mg(OR¹)ₓX¹₂₋ₓ.

R¹ is a hydrocarbyl group independently selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. Preferably, said hydrocarbyl group is an alkyl group, preferably having from 1 to 20 carbon atoms, more preferably from 1 to 12 carbon atoms, even more preferably from 1 to 6 carbon atoms. Most preferably selected from ethyl and methyl.

X¹ is selected from the group of consisting of fluoride (F−), chloride (Cl−), bromide (Br−) or iodide (I−). Preferably, X¹ is chloride or bromine and more preferably, X¹ is chloride.

The value for x is in the range of larger than 0 and smaller than 2: 0<z<2. The value for x is preferably from 0.5 to 1.5.

### Phase B: Activating Said Solid Support for the Catalyst.

This step of activating said solid support for the catalyst is an optional step that is not required, but is preferred, in the present invention. If this step of activation is carried out, preferably, the process for activating said solid support comprises the following step ii). This phase may comprise one or more stages.

### Step ii) Activation of the Solid Magnesium Compound.

Step ii): contacting the solid Mg(OR¹)ₓX¹₂₋ₓ with at least one activating compound selected from the group formed by activating electron donors and metal alkoxide compounds of formula M¹(OR²)_{v-w}(OR³)_{w} or M²(OR²)_{v-w}(R³)_{w}, wherein:

R² is a hydrocarbyl group independently selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. Preferably, said hydrocarbyl group is an alkyl group, preferably having from 1 to 20 carbon atoms, more preferably from 1 to 12 carbon atoms, even more preferably from 1 to 6 carbon atoms, such as for example methyl, ethyl, n-propyl, isopropyl, n-butyl, sec-butyl, iso-butyl, tert-butyl, pentyl or hexyl; most preferably selected from ethyl and methyl.

R³ is a hydrocarbyl group independently selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. Preferably, said hydrocarbyl group is an alkyl group, preferably having from 1 to 20 carbon atoms, more preferably from 1 to 12 carbon atoms, even more preferably from 1 to 6 carbon atoms; most preferably selected from methyl, ethyl, n-propyl, isopropyl, n-butyl, sec-butyl, iso-butyl, tert-butyl, and cyclopentyl.

M¹ is a metal selected from the group consisting of Ti, Zr, Hf, Al or Si; v is the valency of M¹; M² is a metal being Si; v is the valency of M² and w is smaller than v; v being either 3 or 4.

The electron donors and the compounds of formula M(OR²)_{v-w}(OR³)_{w} and M(OR²)_{v-w}(R³)_{w} may be also referred herein as activating compounds.

In this step either one or both types of activating compounds (viz. activating electron donor or metal alkoxides) may be used.

The advantage of the use of this activation step prior to contacting the solid support with the halogen-containing titanium compound (process phase C) is that a higher yield of polyolefins is obtained per gram of the procatalyst. Moreover, the ethylene sensitivity of the catalyst system in the copolymerisation of propylene and ethylene is also increased because of this activation step. This activation step is disclosed in detail in WO2007/134851 of the present applicant.

Examples of suitable activating electron donors that may be used in step ii) are known to the skilled person and described herein below, i.e. include carboxylic acids, carboxylic acid anhydrides, carboxylic acid esters, carboxylic acid halides, alcohols, ethers, ketones, amines, amides, nitriles, aldehydes, alkoxides, sulphonamides, thioethers, thioesters and other organic compounds containing one or more hetero atoms, such as nitrogen, oxygen, sulphur and/or phosphorus.

Preferably, an alcohol is used as the activating electron donor in step ii). More preferably, the alcohol is a linear or branched aliphatic or aromatic alcohol having 1-12 carbon atoms. Even more preferably, the alcohol is selected from methanol, ethanol, butanol, isobutanol, hexanol, xylenol and benzyl alcohol. Most preferably, the alcohol is ethanol or methanol, preferably ethanol.

Suitable carboxylic acids as activating electron donor may be aliphatic or (partly) aromatic. Examples include formic acid, acetic acid, propionic acid, butyric acid, isobutanoic acid, acrylic acid, methacrylic acid, maleic acid, fumaric acid, tartaric acid, cyclohexanoic monocarboxylic acid, cis-1,2-cyclohexanoic dicarboxylic acid, phenylcarboxylic acid, toluenecarboxylic acid, naphthalene carboxylic acid, phthalic acid, isophthalic acid, terephthalic acid and/or trimellitic acid.

Anhydrides of the aforementioned carboxylic acids can be mentioned as examples of carboxylic acid anhydrides, such as for example acetic acid anhydride, butyric acid anhydride and methacrylic acid anhydride.

Suitable examples of esters of above-mentioned carboxylic acids are formates, for instance, butyl formate; acetates, for instance ethyl acetate and butyl acetate; acrylates, for instance ethyl acrylate, methyl methacrylate and isobutyl methacrylate; benzoates, for instance methylbenzoate and ethylbenzoate; methyl-p-toluate; ethyl-naphthate and phthalates, for instance monomethyl phthalate, dibutyl phthalate, diisobutyl phthalate, diallyl phthalate and/or diphenyl phthalate.

Examples of suitable carboxylic acid halides as activating electron donors are the halides of the carboxylic acids mentioned above, for instance acetyl chloride, acetyl bromide, propionyl chloride, butanoyl chloride, butanoyl iodide, benzoyl bromide, p-toluyl chloride and/or phthaloyl dichloride.

Suitable alcohols are linear or branched aliphatic alcohols with 1-12 C-atoms, or aromatic alcohols. Examples include methanol, ethanol, butanol, isobutanol, hexanol, xylenol and benzyl alcohol. The alcohols may be used alone or in combination. Preferably, the alcohol is ethanol or hexanol.

Examples of suitable ethers are diethyl ethers, such as 2-ethyl-2-butyl-1,3-dimethoxypropane, 2-isopropyl-2-isopentyl-1,3-dimethoxypropane and/or 9,9-bis(methoxymethyl) fluorene. Also, cyclic ethers like tetrahydrofuran (THF), or tri-ethers can be used.

Suitable examples of other organic compounds containing a heteroatom as activating electron donor include 2,2,6,6-tetramethyl piperidine, 2,6-dimethylpiperidine, pyridine, 2-methylpyridine, 4-methylpyridine, imidazole, benzonitrile, aniline, diethylamine, dibutylamine, dimethylacetamide, thiophenol, 2-methyl thiophene, isopropyl mercaptan, diethylthioether, diphenylthioether, tetrahydrofuran, dioxane, dimethylether, diethylether, anisole, acetone, triphenylphosphine, triphenylphosphite, diethylphosphate and/or diphenylphosphate.

Examples of suitable metal alkoxides for use in step ii) are metal alkoxides of formulas: M¹(OR²)_{v-w}(OR³)_{w} and M²(OR²)_{v-w}(R³)_{w} wherein M¹, M², R², R³, v, and w are as defined herein. R² and R³ can also be aromatic hydrocarbon groups, optionally substituted with e.g. alkyl groups and can contain for example from 6 to 20 carbon atoms. The R² and R³ preferably comprise 1-12 or 1-8 carbon atoms. In preferred embodiments R² and R³ are ethyl, propyl or butyl; more preferably all groups are ethyl groups.

Preferably, M¹ in said activating compound is Ti or Si. Si-containing compounds suitable as activating compounds are the same as listed above for step i).

The value of w is preferably 0, the activating compound being for example a titanium tetraalkoxide containing 4-32 carbon atoms in total from four alkoxy groups. The four alkoxide groups in the compound may be the same or may differ independently. Preferably, at least one of the alkoxy groups in the compound is an ethoxy group. More preferably the compound is a tetraalkoxide, such as titanium tetraethoxide.

In the preferred process to prepare the procatalyst, one activating compound can be used, but also a mixture of two or more compounds may be used.

A combination of a compound of M¹(OR²)_{v-w}(OR³)_{w} or M²(OR²)_{v-w}(R³)_{w} with an electron donor is preferred as activating compound to obtain a catalyst system that for example shows high activity, and of which the ethylene sensitivity can be affected by selecting the internal donor; which is specifically advantageous in preparing copolymers of for example propylene and ethylene.

Preferably, a Ti-based compound, for example titanium tetraethoxide, is used together with an alcohol, like ethanol or hexanol, or with an ester compound, like ethylacetate, ethylbenzoate or a phthalate ester or with pyridine.

If two or more activating compounds are used in step ii) their order of addition is not critical, but may affect catalyst performance depending on the compounds used. A skilled person may optimize their order of addition based on some experiments. The compounds of step ii) can be added together or sequentially.

Preferably, an electron donor compound is first added to the compound with formula Mg(OR¹)ₓX¹₂₋ₓ where after a compound of formula M¹(OR²)_{v-w}(OR³)_{w} or M²(OR²)_{v-w}(R³)_{w} as defined herein is added. The activating compounds preferably are added slowly, for instance during a period of 0.1-6, preferably during 0.5-4 hours, most preferably during 1-2.5 hours, each.

The first intermediate reaction product that is obtained in step i) can be contacted—when more than one activating compound is used—in any sequence with the activating compounds. In one embodiment, an activating electron donor is first added to the first intermediate reaction product and then the compound M¹(OR²)_{v-w}(OR³)_{w} or M²(OR²)_{v-w}(R³)_{w} is added; in this order no agglomeration of solid particles is observed. The compounds in step ii) are preferably added slowly, for instance during a period of 0.1-6, preferably during 0.5-4 hours, most preferably during 1-2.5 hours, each.

The molar ratio of the activating compound to Mg(OR¹)ₓX¹₂₋ₓ may range between wide limits and is, for instance, from 0.02 to 1.0. Preferably the molar ratio is from 0.05 to 0.5, more preferably from 0.06 to 0.4, or even from 0.07 to 0.2.

The temperature in step ii) can be in the range from −20° C. to 70° C., preferably from −10° C. to 50° C., more preferably in the range from −5° C. to 40° C., and most preferably in the range from 0° C. to 30° C.

Preferably, at least one of the reaction components is dosed in time, for instance during 0.1 to 6, preferably during 0.5 to 4 hours, more particularly during 1-2.5 hours.

The reaction time after the activating compounds have been added is preferably from 0 to 3 hours.

The mixing speed during the reaction depends on the type of reactor used and the scale of the reactor used. The mixing speed can be determined by a person skilled in the art and should be sufficient to agitate the reactants.

The inert dispersant used in step ii) is preferably a hydrocarbon solvent. The dispersant may be for example an aliphatic or aromatic hydrocarbon having from 1 to 20 carbon atoms. Preferably, the dispersant is an aliphatic hydrocarbon, more preferably pentane, iso-pentane, hexane or heptane, heptane being most preferred.

Starting from a solid Mg-containing product of controlled morphology obtained in step i), said morphology is not negatively affected during treatment with the activating compound during step ii). The solid second intermediate reaction product obtained in step ii) is considered to be an adduct of the Mg-containing compound and the at least one activating compound as defined in step ii), and is still of controlled morphology.

The obtained second intermediate reaction product after step ii) may be a solid and may be further washed, preferably with the solvent also used as inert dispersant; and then stored and further used as a suspension in said inert solvent. Alternatively, the product may be dried, preferably partly dried, preferably slowly and under mild conditions; e.g. at ambient temperature and pressure.

This second intermediate reaction product is preferably then contacted in step iii) with titanium tetrachloride, a monoester, the first internal donor compound represented by Formula A, for example a Fischer projection of Formula A, and optionally a second internal electron donor selected from a group consisting of diesters and diethers.

Phase C: Contacting Said Solid Support with the Catalytic Species, and One or More Internal Donors and an Activator.

Phase C: contacting the solid support with a catalytic species. This step can take different forms, such as i) contacting said solid support with the catalytic species, an activator and one or more internal donors to obtain said procatalyst; ii) contacting said solid support with a catalytic species, an activator and one or more internal donors to obtain an intermediate product; iii) contacting said solid support with a catalytic species and an activator donor to obtain an intermediate product.

Phase C may comprise several stages. During each of these consecutive stages the solid support is contacted with said catalytic species. In other words, the addition or reaction of said catalytic species may be repeated one or more times.

For example, during stage I of phase C said solid support (first intermediate) or the activated solid support (second intermediate) is first contacted with said catalytic species and optionally subsequently with an internal donor. When a second stage is present, during stage II the intermediate product obtained from stage I will be contacted with additional catalytic species which may the same or different than the catalytic species added during the first stage and optionally an internal donor. In case three stages are present, stage III is preferably a repetition of stage II or may comprise the contacting of the product obtained from stage II with both a catalytic species (which may be the same or different as above) and an activator and an internal donor. In other words, the internal donor may be added during each of these stages or during two or more of these stages. When an internal donor is added during more than one stage it may be the same or a different internal donor. An internal donor compound represented by Formula A, for example a Fischer projection of Formula A, is added during at least one of the stages of Phase C.

The monoester as activator according to the present invention may be added either during stage I or stage II or stage III. The monoester may also be added during more than one stage.

Preferably, the process of contacting said solid support with the catalytic species and an internal donor comprises the following step iii).

Step iii) Reacting the Solid Support with a Transition Metal Halide

Step iii) reacting the solid support with a transition metal halide (e.g. titanium, chromium, hafnium, zirconium, vanadium) but preferably titanium halide. In the discussion below only the process for a titanium-base Ziegler-Natta procatalyst is disclosed, however, the application is also applicable to other types of Ziegler-Natta procatalysts.

Step iii): contacting the first or second intermediate reaction product, obtained respectively in step i) or ii), with a halogen-containing Ti-compound and optionally an internal electron donor or activator to obtain a third intermediate product.

The second intermediate reaction product can be contacted with the halogen-containing Ti-compound, the monoester, the compound represented by Formula A, for example a Fischer projection of Formula A, and optionally, the second internal electron donor in any order, at any time and any stage that the contacting reaction may be performed at and by applying any method known to the skilled person in the art.

Step iii) can be carried out after step i) on the first intermediate product or after step ii) on the second intermediate product.

The molar ratio in step iii) of the transition metal to the magnesium preferably is from 10 to 100, most preferably, from 10 to 50.

Preferably, an internal electron donor is also present during step iii). Also mixtures of internal electron donors can be used. Examples of internal electron donors are disclosed below.

The molar ratio of the internal electron donor relative to the magnesium may vary between wide limits, for instance from 0.02 to 0.75. Preferably, this molar ratio is from 0.05 to 0.4; more preferably from 0.1 to 0.4; and most preferably from 0.1 to 0.3.

During contacting the second intermediate product and the halogen-containing titanium compound, an inert dispersant is preferably used. The dispersant preferably is chosen such that virtually all side products formed are dissolved in the dispersant. Suitable dispersants include for example aliphatic and aromatic hydrocarbons and halogenated aromatic solvents with for instance 4-20 carbon atoms. Examples include toluene, xylene, benzene, heptane, o-chlorotoluene and chlorobenzene.

The reaction temperature during step iii) is preferably from 0° C. to 150° C., more preferably from 50° C. to 150° C., and more preferably from 100° C. to 140° C. Most preferably, the reaction temperature is from 110° C. to 125° C.

The reaction time during step iii) is preferably from 10 minutes to 10 hours. In case several stages are present, each stage can have a reaction time from 10 minutes to 10 hours. The reaction time can be determined by a person skilled in the art based on the reactor and the procatalyst.

The mixing speed during the reaction depends on the type of reactor used and the scale of the reactor used. The mixing speed can be determined by a person skilled in the art and should be sufficient to agitate the reactants.

The obtained reaction product may be washed, usually with an inert aliphatic or aromatic hydrocarbon or halogenated aromatic compound, to obtain the procatalyst of the invention. If desired the reaction and subsequent purification steps may be repeated one or more times. A final washing is preferably performed with an aliphatic hydrocarbon to result in a suspended or at least partly dried procatalyst, as described above for the other steps.

Optionally an activator is present during step iii) of Phase C instead of an internal donor, this is explained in more detail below in the section of activators.

The molar ratio of the activator relative to the magnesium may vary between wide limits, for instance from 0.02 to 0.5. Preferably, this molar ratio is from 0.05 to 0.4; more preferably from 0.1 to 0.3; and most preferably from 0.1 to 0.2.

Phase D: Modifying Said Intermediate Product with a Metal-Based Modifier.

This phase D is optional in the present invention. In a preferred process for modifying the supported catalyst, this phase consists of the following steps: Step iv) modifying the third intermediate product with a metal-modifier to yield a modified intermediate product; Step v) contacting said modified intermediate product with a titanium halide and optionally on or more internal donors to obtain the present procatalyst.

The order of addition, viz. the order of first step iv) and subsequently step v) is considered to be very important to the formation of the correct clusters of Group 13- or transition metal and titanium forming the modified and more active catalytic centre.

Each of these steps is disclosed in more detail below.

It should be noted that the steps iii), iv) and v) (viz. phases C and D) are preferably carried out in the same reactor, viz. in the same reaction mixture, directly following each other.

Preferably step iv) is carried out directly after step iii) in the same reactor. Preferably, step v) is carried out directly after step iv) in the same reactor.

### Step iv): Group 13- or Transition Metal Modification

The modification with Group 13- or transition metal, preferably aluminium, ensures the presence of Group 13- or transition metal in the procatalyst, in addition to magnesium (from the solid support) and titanium (from the titanation treatment).

Without wishing to be bound by any particular theory, the present inventors believe that one possible explanation is that the presence of Group 13- or transition metal increases the reactivity of the active site and hence increases the yield of polymer.

Step iv) comprises modifying the third intermediate product obtained in step iii) with a modifier having the formula MX₃, wherein M is a metal selected from the Group 13 metals and transition metals of the IUPAC periodic table of elements, and wherein X is a halide to yield a modified intermediate product.

Step iv) is preferably carried out directly after step iii), more preferably in the same reactor and preferably in the same reaction mixture. In an embodiment, a mixture of aluminum trichloride and a solvent, e.g. chlorobenzene, is added to the reactor after step iii) has been carried out. After the reaction has completed a solid is allowed to settle which can either be obtained by decanting or filtration and optionally purified or a suspension of which in the solvent can be used for the following step, viz. step v).

The metal modifier is preferably selected from the group of aluminium modifiers (e.g. aluminium halides), boron modifiers (e.g. boron halides), gallium modifiers (e.g. gallium halides), zinc modifiers (e.g. zinc halides), copper modifiers (e.g. copper halides), thallium modifiers (e.g. thallium halides), indium modifiers (e.g. indium halides), vanadium modifiers (e.g. vanadium halides), chromium modifiers (e.g. chromium halides), iron modifiers (e.g. iron halides).

Examples of suitable modifiers are aluminum trichloride, aluminum tribromide, aluminum triiodide, aluminum trifluoride, boron trichloride, boron tribromide boron triiodide, boron trifluoride, gallium trichloride, gallium tribromide, gallium triiodide, gallium trifluoride, zinc dichloride, zinc dibromide, zinc diiodide, zinc difluoride, copper dichloride, copper dibromide, copper diiodide, copper difluoride, copper chloride, copper bromide, copper iodide, copper fluoride, thallium trichloride, thallium tribromide, thallium triiodide, thallium trifluoride, thallium chloride, thallium bromide, thallium iodide, thallium fluoride, Indium trichloride, indium tribromide, indium triiodide, indium trifluoride, vanadium trichloride, vanadium tribromide, vanadium triiodide, vanadium trifluoride, chromium trichloride, chromium dichloride, chromium tribromide, chromium dibromide, iron dichloride, iron trichloride, iron tribromide, iron dichloride, iron triiodide, iron diiodide, iron trifluoride, iron difluoride.

The amount of metal halide added during step iv) may vary according to the desired amount of metal present in the procatalyst. It may for example range from 0.1 to 5 wt. % based on the total weight of the support, preferably from 0.5 to 1.5 wt. % was carried out directly after step iii) in the same reactor.

The metal halide is preferably mixed with a solvent prior to the addition to the reaction mixture. The solvent for this step may be selected from for example aliphatic and aromatic hydrocarbons and halogenated aromatic solvents with for instance 4-20 carbon atoms. Examples include toluene, xylene, benzene, decane, o-chlorotoluene and chlorobenzene. The solvent may also be a mixture or two or more thereof.

The duration of the modification step may vary from 1 minute to 120 minutes, preferably from 40 to 80 minutes, more preferably from 50 to 70 minutes. This time is dependent on the concentration of the modifier, the temperature, the type of solvent used etc.

The modification step is preferably carried out at elevated temperatures (e.g. from 50 to 120° C., preferably from 90 to 110° C.).

The modification step may be carried out while stirring. The mixing speed during the reaction depends on the type of reactor used and the scale of the reactor used. The mixing speed can be determined by a person skilled in the art. As a non-limiting example, mixing may be carried at a stirring speed from 100 to 400 rpm, preferably from 150 to 300 rpm, more preferably about 200 rpm).

The wt/vol ratio for the metal halide and the solvent in step iv) is from 0.01 gram-0.1 gram:5.0-100 ml.

The modified intermediate product is present in a solvent. It can be kept in that solvent after which the following step v) is directly carried out. However, it can also be isolated and/or purified. The solid can be allowed to settle by stopping the stirring. The supernatant can than be removed by decanting. Otherwise, filtration of the suspension is also possible. The solid product may be washed once or several times with the same solvent used during the reaction or another solvent selected from the same group described above. The solid may be resuspended or may be dried or partially dried for storage.

Subsequent to this step, step v) is carried out to produce the procatalyst according to the present invention.

### Step v): Additional Treatment of Intermediate Product.

This step is very similar to step iii). It contains the additional treatment of the modified intermediate product.

Step v) contacting said modified intermediate product obtained in step iv) with a halogen-containing titanium compound to obtain the procatalyst according to the present invention. When an activator is used during step iii) an internal donor may be used during this step.

Step v) is preferably carried out directly after step iv), more preferably in the same reactor and preferably in the same reaction mixture.

In an embodiment, at the end of step iv) or at the beginning of step v) the supernatant was removed from the solid modified intermediate product obtained in step iv) by filtration or by decanting. To the remaining solid, a mixture of titanium halide (e.g. tetrachloride) and a solvent (e.g. chlorobenzene) can be added. The reaction mixture is subsequently kept at an elevated temperature (e.g. from 100 to 130° C., such as 115° C.) for a certain period of time (e.g. from 10 to 120 minutes, such as from 20 to 60 minutes, e.g. 30 minutes). After this, a solid substance was allowed to settle by stopping the stirring.

The molar ratio of the transition metal to the magnesium preferably is from 10 to 100, most preferably, from 10 to 50.

Optionally, additional internal electron donor may also present during this step. Also mixtures of internal electron donors can be used. The molar ratio of the internal electron donor relative to the magnesium may vary between wide limits, for instance from 0.02 to 0.75. Preferably, this molar ratio is from 0.05 to 0.4; more preferably from 0.1 to 0.4; and most preferably from 0.1 to 0.3.

The solvent for this step may be selected from for example aliphatic and aromatic hydrocarbons and halogenated aromatic solvents with for instance 4-20 carbon atoms. The solvent may also be a mixture or two or more thereof.

According to a preferred embodiment of the present invention this step v) is repeated, in other words, the supernatant is removed as described above and a mixture of titanium halide (e.g. tetrachloride) and a solvent (e.g. chlorobenzene) is added. The reaction is continued at elevated temperatures during a certain time which can be same or different from the first time step v) is carried out.

The step may be carried out while stirring. The mixing speed during the reaction depends on the type of reactor used and the scale of the reactor used. The mixing speed can be determined by a person skilled in the art. This can be the same as discussed above for step iii).

Thus, step v) can be considered to consist of at least two sub steps in this embodiment, being:

v-a) contacting said modified intermediate product obtained in step iv) with titanium tetrachloride—optionally using an internal donor—to obtain a partially titanated procatalyst;
v-b) contacting said partially titanated procatalyst obtained in step v-a) with titanium tetrachloride to obtain the procatalyst.

Additional sub steps can be present to increase the number of titanation steps to four or higher.

The solid substance (procatalyst) obtained was washed several times with a solvent (e.g. heptane), preferably at elevated temperature, e.g. from 40 to 100° C. depending on the boiling point of the solvent used, preferably from 50 to 70° C. After this, the procatalyst, suspended in solvent, was obtained. The solvent can be removed by filtration or decantation. The procatalyst can be used as such wetted by the solvent or suspended in solvent or it can be first dried, preferably partly dried, for storage. Drying can e.g. be carried out by low pressure nitrogen flow for several hours.

Thus in this embodiment, the total titanation treatment comprises three phases of addition of titanium halide. Wherein the first phase of addition is separated from the second and third phases of addition by the modification with metal halide.

The titanation step (viz. the step of contacting with a titanium halide) according to this specific aspect of the present invention is split into two parts and a Group 13- or transition metal modification step is introduced between the two parts or stages of the titanation. Preferably, the first part of the titanation comprises one single titanation step and the second part of the titanation comprises two subsequent titanation steps. When this modification is carried out before the titanation step the increase in activity was higher as observed by the inventors. When this modification is carried out after the titanation step the increase in activity was less as observed by the present inventors.

In short, an embodiment of the present invention comprises the following steps: i) preparation of first intermediate reaction product; ii) activation of solid support to yield second intermediate reaction product; iii) first titanation or Stage I to yield third intermediate reaction product; iv) modification to yield modified intermediate product; v) second titanation or Stage II/111 to yield the procatalyst.

The procatalyst may have a titanium, hafnium, zirconium, chromium or vanadium (preferably titanium) content of from about 0.1 wt % to about 6.0 wt %, based on the total solids weight, or from about 1.0 wt % to about 4.5 wt %, or from about 1.5 wt % to about 3.5 wt %.

The weight ratio of titanium, hafnium, zirconium, chromium or vanadium (preferably titanium) to magnesium in the solid procatalyst may be from about 1:3 to about 1:160, or from about 1:4 to about 1:50, or from about 1:6 to 1:30. Weight percentage is based on the total weight of the procatalyst.

The intermediate product may further be activated during Phase C as discussed above for the process. This activation increases the yield of the resulting procatalyst in olefin polymerisation.

In the present invention a monoester activator is always present. It is possible that an additional activator is present, such as benzamide or alkylbenzoates.

A benzamide activator has a structure according to formula X:

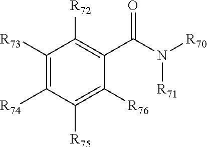

R⁷⁰ and R⁷¹ are each independently selected from hydrogen or an alkyl. Preferably, said alkyl has from 1 to 6 carbon atoms, more preferably from 1 to 3 carbon atoms. More preferably, R⁷⁰ and R⁷¹ are each independently selected from hydrogen or methyl.

R⁷², R⁷³, R⁷⁴, R⁷⁵, R⁷⁶ are each independently selected from hydrogen, a heteroatom (preferably a halide), or a hydrocarbyl group, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 10 carbon atoms, more preferably from 1 to 8 carbon atoms, even more preferably from 1 to 6 carbon atoms.

Suitable non-limiting examples of “benzamides” include benzamide (R⁷⁰ and R⁷¹ are both hydrogen and each of R⁷², R⁷³, R⁷⁴, R⁷⁵, R⁷⁶ are hydrogen) also denoted as BA-2H or methylbenzamide (R⁷⁰ is hydrogen; R⁷¹ is methyl and each of R⁷², R⁷³, R⁷⁴, R⁷⁵, R⁷⁶ are hydrogen) also denoted as BA-HMe or dimethylbenzamide (R⁷⁰ and R⁷¹ are methyl and each of R⁷², R⁷³, R⁷⁴, R⁷⁵, R⁷⁶ are hydrogen) also denoted as BA-2Me. Other examples include monoethylbenzamide, diethylbenzamide, methylethylbenzamide, 2-(trifluormethyl)benzamide, N,N-dimethyl-2-(trifluormethyl)benzamide, 3-(trifluormethyl)benzamide, N,N-dimethyl-3-(trifluormethyl)benzamide, 2,4-dihydroxy-N-(2-hydroxyethyl)benzamide, N-(1H-benzotriazol-1-ylmethyl)benzamide, 1-(4-ethylbenzoyl)piperazine, 1-benzoylpiperidine.

It has surprisingly been found by the present inventors that when the benzamide activator is added during the first stage of the process together with the catalytic species or directly after the addition of the catalytic species (e.g. within 5 minutes) an even higher increase in the yield is observed compared to when the activator is added during stage II or stage III of the process.

It has surprisingly been found by the present inventors that the benzamide activator having two alkyl groups (e.g. dimethylbenzamide or diethylbenzamide, preferably dimethylbenzamide) provides an even higher increase in the yield than either benzamide or monoalkyl benzamide.

Without wishing to be bound by a particular theory the present inventors believe that the fact that the most effective activation is obtained when the benzamide activator is added during stage I has the following reason. It is believed that the benzamide activator will bind the catalytic species and is later on substituted by the internal donor when the internal donor is added.

Alkylbenzoates may be used as activators. The activator may hence be selected from the group alkylbenzoates having an alkylgroup having from 1 to 10, preferably from 1 to 6 carbon atoms. Examples of suitable alkyl benzoates are methylbenzoate, ethylbenzoate according to Formula II, n-propylbenzoate, iso-propylbenzoate, n-butylbenzoate, 2-butylbenzoate, t-butylbenzoate.

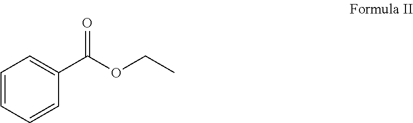

More preferably, the activator is ethylbenzoate.

The catalyst system according to the present invention includes a co-catalyst. As used herein, a “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990).

The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst represented by the formula R²⁰₃Al.

R²⁰ is independently selected from a hydrogen or a hydrocarbyl, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. On the proviso that at least one R²⁰ is a hydrocarbyl group. Optionally, two or three R²⁰ groups are joined in a cyclic radical forming a heterocyclic structure.

Non-limiting examples of suitable R²⁰ groups are: methyl, ethyl, propyl, isopropyl, butyl, isobutyl, tert-butyl, pentyl, neopentyl, hexyl, 2-methylpentyl, heptyl, octyl, isooctyl, 2-ethylhexyl, 5,5-dimethylhexyl, nonyl, decyl, isodecyl, undecyl, dodecyl, phenyl, phenethyl, methoxyphenyl, benzyl, tolyl, xylyl, naphthyl, methylnapthyl, cyclohexyl, cycloheptyl, and cyclooctyl.

Suitable examples of the hydrocarbyl aluminum compounds as co-catalyst include triisobutylaluminum, trihexylaluminum, di-isobutylaluminum hydride, dihexylaluminum hydride, isobutylaluminum dihydride, hexylaluminum dihydride, diisobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, and tritolylaluminum. In an embodiment, the cocatalyst is selected from triethylaluminum, triisobutylaluminum, trihexylaluminum, di-isobutylaluminum hydride and dihexylaluminum hydride. More preferably, trimethylaluminium, triethylaluminium, triisobutylaluminium, and/or trioctylaluminium. Most preferably, triethylaluminium (abbreviated as TEAL).

Preferably, the co-catalyst is triethylaluminum. The molar ratio of aluminum to titanium may be from about 5:1 to about 500:1 or from about 10:1 to about 200:1 or from about 15:1 to about 150:1 or from about 20:1 to about 100:1. The molar ratio of aluminum to titanium is preferably about 45:1.

An external electron donor may also be present in the catalyst system according to the present invention. One of the functions of an external donor compound is to affect the stereoselectivity of the catalyst system in polymerization of olefins having three or more carbon atoms. Therefore it may be also referred to as a selectivity control agent.

Examples of external donors suitable for use in the present invention are benzoic acid esters, 1,3-diethers, alkylamino-alkoxysilanes, alkyl-alkoxysilane, imidosilanes, and alkylimidosilanes.

The aluminium/external donor molar ratio in the polymerization catalyst system preferably is from 0.1 to 200; more preferably from 1 to 100.

Mixtures of external donors may be present and may include from about 0.1 mol % to about 99.9% mol % of a first external donor and from about 99.9 mol % to about 0.1 mol % of either a second or the additional alkoxysilane external donor disclosed below.

When a silane external donor is used, the Si/Ti molar ratio in the catalyst system can range from 0.1 to 40, preferably from 0.1 to 20, even more preferably from 1 to 20 and most preferably from 2 to 10.

Documents EP1538167 and EP1783145 disclose a Ziegler-Natta catalyst type comprising an organo-silicon compound as external donor that is represented by formula Si(OR^{c})₃(NR^{d}R^{e}), wherein R^{c} is a hydrocarbon group having 1 to 6 carbon atoms, R^{d} is a hydrocarbon group having 1 to 12 carbon atoms or hydrogen atom, and R^{e} is a hydrocarbon group having 1 to 12 carbon atoms used as an external electron donor.

An other example of a suitable external donor according to the present invention is a compound according to Formula III:

(R⁹⁰)₂N-A-Si(OR⁹¹)₃

The R⁹⁰ and R⁹¹ groups are each independently an alkyl having from 1 to 10 carbon atoms. Said alkyl group may be linear, branched or cyclic. Said alkyl group may be substituted or unsubstituted. Preferably, said hydrocarbyl group has from 1 to 8 carbon atoms, even more preferably from 1 to 6 carbon atoms, even more preferably from 2 to 4 carbon atoms. Preferably each R⁹⁰ is ethyl. Preferably each R⁹¹ is ethyl. A is either a direct bond between nitrogen and silicon or a spacer selected from an alkyl having 1-10 carbon atoms, preferably a direct bond. An example of such an external donor is diethyl-amino-triethoxysilane (DEATES) wherein A is a direct bond, each R⁹⁰ is ethyl and each R⁹¹ is ethyl.

Alkyl-alkoxysilanes according to Formula IV may be used:

(R⁹²)Si(OR⁹³)₃ Formula IV

The R⁹² and R⁹³ groups are each independently an alkyl having from 1 to 10 carbon atoms. Said alkyl group may be linear, branched or cyclic. Said alkyl group may be substituted or unsubstituted. Preferably, said hydrocarbyl group has from 1 to 8 carbon atoms, even more preferably from 1 to 6 carbon atoms, even more preferably from 2 to 4 carbon atoms. Preferably, all three R⁹³ groups are the same. Preferably R⁹³ is methyl or ethyl. Preferably R⁹² is ethyl or propyl, more preferably n-propyl.

Typical external donors known in the art (for instance as disclosed in documents WO2006/056338A1, EP1838741B1, U.S. Pat. No. 6,395,670B1, EP398698A1, WO96/32426A) are organosilicon compounds having general formula Si(OR^{a})₄₋ₙR^{b}ₙ, wherein n can be from 0 up to 2, and each R^{a} and R^{b}, independently, represents an alkyl or aryl group, optionally containing one or more hetero atoms for instance O, N, S or P, with, for instance, 1-20 carbon atoms; such as n-propyl trimethoxysilane (nPTMS), n-propyl triethoxysilane (nPEMS), diisobutyl dimethoxysilane (DiBDMS), tert-butyl isopropyl dimethyxysilane (tBiPDMS), cyclohexyl methyldimethoxysilane (CHMDMS), dicyclopentyl dimethoxysilane (DCPDMS) or di(iso-propyl) dimethoxysilane (DiPDMS).

Imidosilanes according to Formula I may be used as external donors.

Si(L)ₙ(OR¹¹)₄₋ₙ Formula I

wherein,
Si is a silicon atom with valency 4+;
O is an oxygen atom with valency 2− and O is bonded to Si via a silicon-oxygen bond;
n is 1, 2, 3 or 4;
R¹¹ is selected from the group consisting of linear, branched and cyclic alkyl having at most 20 carbon atoms and aromatic substituted and unsubstituted hydrocarbyl having 6 to 20 carbon atoms; two R¹¹ groups can be connected and together may form a cyclic structure; and L is a group represented by Formula I″

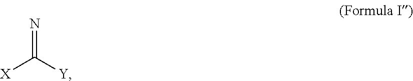

wherein,
L is bonded to the silicon atom via a nitrogen-silicon bond;
L has a single substituent on the nitrogen atom, where this single substituent is an imine carbon atom; and
X and Y are each independently selected from the group consisting of:
a) a hydrogen atom;
b) a group comprising a heteroatom selected from group 13, 14, 15, 16 or 17 of the IUPAC Periodic Table of the Elements, through which X and Y are each independently bonded to the imine carbon atom of Formula II, wherein the heteroatom is substituted with a group consisting of a linear, branched and cyclic alkyl having at most 20 carbon atoms, optionally containing a heteroatom selected from group 13, 14, 15, 16 or 17 of the IUPAC Periodic Table of the Elements; and/or with an aromatic substituted and unsubstituted hydrocarbyl having 6 to 20 carbon atoms, optionally containing a heteroatom selected from group 13, 14, 15, 16 or 17 of the IUPAC Periodic Table of the Elements;
c) a linear, branched and cyclic alkyl having at most 20 carbon atoms, optionally containing a heteroatom selected from group 13, 14, 15, 16 or 17 of the IUPAC Periodic Table of the Elements; and
d) an aromatic substituted and unsubstituted hydrocarbyl having 6 to 20 carbon atoms, optionally containing a heteroatom selected from group 13, 14, 15, 16 or 17 of the IUPAC.

R¹¹ is selected from the group consisting of linear, branched and cyclic alkyl having at most 20 carbon atoms.

Preferably, R¹¹ is a selected from the group consisting of linear, branched and cyclic alkyl having at most 20 carbon atoms, preferably 1 to 10 carbon atoms or 3 to 10 carbon atoms, more preferably 1 to 6 carbon atoms.

Suitable examples of R¹¹ include methyl, ethyl, n-propyl, iso-propyl, n-butyl, iso-butyl, tert-butyl, sec-butyl, iso-butyl, n-pentyl, iso-pentyl, cyclopentyl, n-hexyl and cyclohexyl. More preferably, R¹¹ is a linear alkyl having 1 to 10, even more preferably 1 to 6 carbon atoms. Most preferably, R¹¹ is methyl or ethyl.

R¹² is selected from the group consisting of a linear, branched and cyclic hydrocarbyl group independently selected from alkyl, alkenyl, aryl, aralkyl, alkoxycarbonyl or alkylaryl groups, and one or more combinations thereof. Said hydrocarbyl group may be substituted or unsubstituted. Said hydrocarbyl group may contain one or more heteroatoms. Preferably, said hydrocarbyl group has from 1 to 20 carbon atoms.

Suitable examples of R¹² include methyl, ethyl, n-propyl, iso-propyl, n-butyl, iso-butyl, tert-butyl, sec-butyl, iso-butyl, n-pentyl, iso-pentyl, cyclopentyl, n-hexyl, cyclohexyl, unsubstituted or substituted phenyl.

Specific examples are the following compounds: 1,1,1-triethoxy-N-(2,2,4,4-tetramethylpentan-3-ylidene) silanamine (all R¹¹ groups are=ethyl and X and Y are both tert-butyl); 1,1,1-trimethoxy-N-(2,2,4,4-tetramethylpentan-3-ylidene) silanamine (all R¹¹ groups are methyl, and X and Y are tert butyl), N,N,N′,N′-tetramethylguanidine triethoxysilane (all R11 groups are ethyl, both X and Y are dimethylamino).

Alkylimidosilanes according to Formula I′ may be used as external donors.

Si(L)ₙ(OR¹¹)₄₋ₙ₋ₘ(R¹²)ₘ Formula I′

wherein,
Si is a silicon atom with valency 4+;
O is an oxygen atom with valency 2− and O is bonded to Si via a silicon-oxygen bond;
n is 1, 2, 3 or 4;
m is 0, 1 or 2
n+m≦4
R¹¹ is selected from the group consisting of linear, branched and cyclic alkyl having at most 20 carbon atoms and aromatic substituted and unsubstituted hydrocarbyl having 6 to 20 carbon atoms; and
R¹² is selected from the group consisting of linear, branched and cyclic alkyl having at most 20 carbon atoms and aromatic substituted and unsubstituted hydrocarbyl having 6 to 20 carbon atoms;
L is a group represented by Formula I″

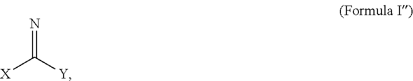

wherein,
L is bonded to the silicon atom via a nitrogen-silicon bond;
L has a single substituent on the nitrogen atom, where this single substituent is an imine carbon atom; and
X and Y are each independently selected from the group consisting of:
a) a hydrogen atom;
b) a group comprising a heteroatom selected from group 13, 14, 15, 16 or 17 of the IUPAC Periodic Table of the Elements, through which X and Y are each independently bonded to the imine carbon atom of Formula II, wherein the heteroatom is substituted with a group consisting of a linear, branched and cyclic alkyl having at most 20 carbon atoms, optionally containing a heteroatom selected from group 13, 14, 15, 16 or 17 of the IUPAC Periodic Table of the Elements; and/or with an aromatic substituted and unsubstituted hydrocarbyl having 6 to 20 carbon atoms, optionally containing a heteroatom selected from group 13, 14, 15, 16 or 17 of the IUPAC Periodic Table of the Elements;
c) a linear, branched and cyclic alkyl having at most 20 carbon atoms, optionally containing a heteroatom selected from group 13, 14, 15, 16 or 17 of the IUPAC Periodic Table of the Elements; and
d) an aromatic substituted and unsubstituted hydrocarbyl having 6 to 20 carbon atoms, optionally containing a heteroatom selected from group 13, 14, 15, 16 or 17 of the IUPAC Periodic Table of the Elements.

R¹¹ and R¹² are as discussed above.

In a first specific example, the external donor may have a structure corresponding to Formula I′ wherein n=1, m=2, X=Y=phenyl, both R¹² groups are methyl, and R¹¹ is butyl.

In a second specific example, the external donor may have a structure corresponding to Formula I′ wherein n=4, m=0, X=methyl, and Y=ethyl.

In a third specific example, the external donor may have a structure corresponding to Formula I′ wherein n=1, m=1, X=phenyl, Y=—CH₂—Si(CH₃)₃, and R¹²=R¹¹=methyl.

In a fourth specific example, the external donor may have a structure corresponding to Formula I′ wherein n=1, m=1, X=—NH—C═NH(NH₂)—, Y=—NH—(CH₂)₃—Si(OCH₂CH₃)₃, and R¹²=—(CH₂)₃—NH₂; R¹¹=ethyl.

The additional compound(s) in the external donor according to the invention may be one or more alkoxysilanes. The alkoxysilane compound can have any of the structures disclosed herein. The alkoxysilane is described by Formula IX

SiR⁷ᵣ(OR⁸)₄₋ᵣ (Formula IX)

R⁷ is independently a hydrocarbyl, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 6 to 12 carbon atoms, even more preferably from 3 to 12 carbon atoms. For example, R⁷ may be C₆₋₁₂ aryl, alkyl or aralkyl, C3-12 cycloalkyl, C₃₋₁₂ branched alkyl, or C₃₋₁₂ cyclic or acyclic amino group. The value for r is selected from 1 or 2.

For the formula SiNR⁷r(OR⁸)₄₋ᵣR⁷ may also be hydrogen.

R⁸ is independently selected from a hydrogen or a hydrocarbyl, selected from alkyl, alkenyl, aryl, aralkyl, alkoxycarbonyl or alkylaryl groups, and one or more combinations thereof. Said hydrocarbyl group may be linear, branched or cyclic. Said hydrocarbyl group may be substituted or unsubstituted. Said hydrocarbyl group may contain one or more heteroatoms. Preferably, said hydrocarbyl group has from 1 to 20 carbon atoms, more preferably from 1 to 12 carbon atoms, even more preferably from 1 to 6 carbon atoms. For example, R⁸ may be C₁₋₄ alkyl, preferably methyl or ethyl

Non-limiting examples of suitable silane-compounds include tetramethoxysilane (TMOS or tetramethyl orthosilicate), tetraethoxysilane (TEOS or tetraethyl orthosilicate), methyl trimethoxysilane, methyl triethoxysilane, methyl tripropoxysilane, methyl tributoxysilane, ethyl trimethoxysilane, ethyl triethoxysilane, ethyl tripropoxysilane, ethyl tributoxysilane, n-propyl trimethoxysilane, n-propyl triethoxysilane, n-propyl tripropoxysilane, n-propyl tributoxysilane, isopropyl trimethoxysilane, isopropyl triethoxysilane, isopropyl tripropoxysilane, isopropyl tributoxysilane, phenyl trimethoxysilane, phenyl triethoxysilane, phenyl tripropoxysilane, phenyl tributoxysilane, cyclopentyl trimethoxysilane, cyclopentyl triethoxysilane, diethylamino triethoxysilane, dimethyl dimethoxysilane, dimethyl diethoxysilane, dimethyl dipropoxysilane, dimethyl dibutoxysilane, diethyl dimethoxysilane, diethyl diethoxysilane, diethyl dipropoxysilane, diethyl dibutoxysilane, di-n-propyl dimethoxysilane, d-n-propyl diethoxysilane, di-n-propyl dipropoxysilane, di-n-propyl dibutoxysilane, diisopropyl dimethoxysilane, diisopropyl diethoxysilane, diisopropyl dipropoxysilane, diisopropyl dibutoxysilane, diphenyl dimethoxysilane, diphenyl diethoxysilane, diphenyl dipropoxysilane, diphenyl dibutoxysilane, dicyclopentyl dimethoxysilane, dicyclopentyl diethoxysilane, diethyl diphenoxysilane, di-tert-butyl dimethoxysilane, methyl cyclohexyl dimethoxysilane, ethyl cyclohexyl dimethoxysilane, isobutyl isopropyl dimethoxysilane, tert-butyl isopropyl dimethoxysilane, trifluoropropyl methyl dimethoxysilane, bis(perhydroisoquinolino) dimethoxysilane, dicyclohexyl dimethoxysilane, dinorbornyl dimethoxysilane, cyclopentyl pyrrolidino dimethoxysilane and bis(pyrrolidino) dimethoxysilane.

In an embodiment, the silane-compound for the additional external donor is dicyclopentyl dimethoxysilane, di-isopropyl dimethoxysilane, di-isobutyl dimethyoxysilane, methylcyclohexyl dimethoxysilane, cyclohexyl methyldimethoxysilane, n-propyl trimethoxysilane, n-propyltriethoxysilane, dimethylamino triethoxysilane, and one or more combinations thereof.

The invention also relates to a process to make the catalyst system by contacting a Ziegler-Natta type procatalyst, a co-catalyst and an external electron donor. The procatalyst, the co-catalyst and the external donor can be contacted in any way known to the skilled person in the art; and as also described herein, more specifically as in the Examples.

The invention further relates to a process for making a polyolefin by contacting an olefin with the catalyst system according to the present invention. The procatalyst, the co-catalyst, the external donor and the olefin can be contacted in any way known to the skilled person in the art; and as also described herein.

For instance, the external donor in the catalyst system according to the present invention can be complexed with the co-catalyst and mixed with the procatalyst (pre-mix) prior to contact between the procatalyst and the olefin. The external donor can also be added independently to the polymerization reactor. The procatalyst, the co-catalyst, and the external donor can be mixed or otherwise combined prior to addition to the polymerization reactor.

Contacting the olefin with the catalyst system according to the present invention can be done under standard polymerization conditions, known to the skilled person in the art. See for example Pasquini, N. (ed.) “Polypropylene handbook” 2^{nd} edition, Carl Hanser Verlag Munich, 2005. Chapter 6.2 and references cited therein.

The polymerization process may be a gas phase, a slurry or a bulk polymerization process, operating in one or more than one reactor. One or more olefin monomers can be introduced in a polymerization reactor to react with the procatalyst and to form an olefin-based polymer (or a fluidized bed of polymer particles).

In the case of polymerization in a slurry (liquid phase), a dispersing agent is present. Suitable dispersing agents include for example propane, n-butane, isobutane, n-pentane, isopentane, hexane (e.g. iso- or n-), heptane (e.g. iso- or n-), octane, cyclohexane, benzene, toluene, xylene, liquid propylene and/or mixtures thereof. The polymerization such as for example the polymerization temperature and time, monomer pressure, avoidance of contamination of catalyst, choice of polymerization medium in slurry processes, the use of further ingredients (like hydrogen) to control polymer molar mass, and other conditions are well known to persons of skill in the art. The polymerization temperature may vary within wide limits and is, for example for propylene polymerization, from 0° C. to 120° C., preferably from 40° C. to 100° C. The pressure during (propylene) (co)polymerization is for instance from 0.1 to 6 MPa, preferably from 1 to 4 MPa.

Several types of polyolefins are prepared such as homopolyolefins, random copolymers and heterophasic polyolefin. The for latter, and especially heterophasic polypropylene, the following is observed.

Heterophasic propylene copolymers are generally prepared in one or more reactors, by polymerization of propylene and optionally one or more other olefins, for example ethylene, in the presence of a catalyst and subsequent polymerization of a propylene-α-olefin mixture. The resulting polymeric materials can show multiple phases (depending on monomer ratio), but the specific morphology usually depends on the preparation method and monomer ratio. The heterophasic propylene copolymers employed in the process according to present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. No. 4,399,054 and U.S. Pat. No. 4,472,524.

The molar mass of the polyolefin obtained during the polymerization can be controlled by adding hydrogen or any other agent known to be suitable for the purpose during the polymerization. The polymerization can be carried out in a continuous mode or batch-wise. Slurry-, bulk-, and gas-phase polymerization processes, multistage processes of each of these types of polymerization processes, or combinations of the different types of polymerization processes in a multistage process are contemplated herein. Preferably, the polymerization process is a single stage gas phase process or a multistage, for instance a two-stage gas phase process, e.g. wherein in each stage a gas-phase process is used or including a separate (small) prepolymerization reactor.

Examples of gas-phase polymerization processes include both stirred bed reactors and fluidized bed reactor systems; such processes are well known in the art. Typical gas phase olefin polymerization reactor systems typically comprise a reactor vessel to which an olefin monomer(s) and a catalyst system can be added and which contain an agitated bed of growing polymer particles. Preferably the polymerization process is a single stage gas phase process or a multistage, for instance a 2-stage, gas phase process wherein in each stage a gas-phase process is used.

As used herein, “gas phase polymerization” is the way of an ascending fluidizing medium, the fluidizing medium containing one or more monomers, in the presence of a catalyst through a fluidized bed of polymer particles maintained in a fluidized state by the fluidizing medium optionally assisted by mechanical agitation. Examples of gas phase polymerization are fluid bed, horizontal stirred bed and vertical stirred bed.

“fluid-bed,” “fluidized,” or “fluidizing” is a gas-solid contacting process in which a bed of finely divided polymer particles is elevated and agitated by a rising stream of gas optionally assisted by mechanical stirring. In a “stirred bed” upwards gas velocity is lower than the fluidization threshold.

A typical gas-phase polymerization reactor (or gas phase reactor) include a vessel (i.e., the reactor), the fluidized bed, a product discharge system and may include a mechanical stirrer, a distribution plate, inlet and outlet piping, a compressor, a cycle gas cooler or heat exchanger. The vessel may include a reaction zone and may include a velocity reduction zone, which is located above the reaction zone (viz. bed). The fluidizing medium may include propylene gas and at least one other gas such as an olefin and/or a carrier gas such as hydrogen or nitrogen. The contacting can occur by way of feeding the procatalyst into the polymerization reactor and introducing the olefin into the polymerization reactor. In an embodiment, the process includes contacting the olefin with a co-catalyst. The co-catalyst can be mixed with the procatalyst (pre-mix) prior to the introduction of the procatalyst into the polymerization reactor. The co-catalyst may be also added to the polymerization reactor independently of the procatalyst. The independent introduction of the co-catalyst into the polymerization reactor can occur (substantially) simultaneously with the procatalyst feed. An external donor may also be present during the polymerization process.

The olefin according to the invention may be selected from mono- and di-olefins containing from 2 to 40 carbon atoms. Suitable olefin monomers include alpha-olefins, such as ethylene, propylene, alpha-olefins having from 4 to 20 carbonatoms (viz. C₄₋₂₀), such as 1-butene, 1-pentene, 1-hexene, 4-methyl-1-pentene, 1-heptene, 1-octene, 1-decene, 1-dodecene and the like; C₄-C₂₀ diolefins, such as 1,3-butadiene, 1,3-pentadiene, norbornadiene, 5-vinyl-2-norbornene (VNB), 1,4-hexadiene, 5-ethylidene-2-norbornene (ENB) and dicyclopentadiene; vinyl aromatic compounds having from 8 to 40 carbon atoms (viz. C₈-C₄₀) including styrene, o-, m- and p-methylstyrene, divinylbenzene, vinylbiphenyl, vinylnaphthalene; and halogen-substituted C₈-C₄₀ vinyl aromatic compounds such as chlorostyrene and fluorostyrene.

Preferably, the olefin is propylene or a mixture of propylene and ethylene, to result in a propylene-based polymer, such as propylene homopolymer or propylene-olefin copolymer. The olefin may an alpha-olefin having up to 10 carbon atoms, such as ethylene, butane, hexane, heptane, octene. A propylene copolymer is herein meant to include both so-called random copolymers which typically have relatively low comonomer content, e.g. up to 10 mol %, as well as so-called impact PP copolymers or heterophasic PP copolymers comprising higher comonomer contents, e.g. from 5 to 80 mol %, more typically from 10 to 60 mol %. The impact PP copolymers are actually blends of different propylene polymers; such copolymers can be made in one or two reactors and can be blends of a first component of low comonomer content and high crystallinity, and a second component of high comonomer content having low crystallinity or even rubbery properties. Such random and impact copolymers are well-known to the skilled in the art. A propylene-ethylene random copolymer may be produced in one reactor. Impact PP copolymers may be produced in two reactors: polypropylene homopolymer may be produced in a first reactor; the content of the first reactor is subsequently transferred to a second reactor into which ethylene (and optionally propylene) is introduced. This results in production of a propylene-ethylene copolymer (i.e. an impact copolymer) in the second reactor.

The present invention also relates to a polyolefin, preferably a polypropylene obtained or obtainable by a process, comprising contacting an olefin, preferably propylene or a mixture of propylene and ethylene with the procatalyst according to the present invention. The terms polypropylene and propylene-based polymer are used herein interchangeable. The polypropylene may be a propylene homopolymer or a mixture of propylene and ethylene, such as a propylene-based copolymer, e.g. heterophasic propylene-olefin copolymer; random propylene-olefin copolymer, preferably the olefin in the propylene-based copolymers being a C2, or C4-C6 olefin, such as ethylene, butylene, pentene or hexene. Such propylene-based (co)polymers are known to the skilled person in the art; they are also described herein.

Said polyolefin has a broad molecular weight distribution and a low amount of atactic fraction and is obtained in high yield.

The present invention also relates to a polyolefin, preferably a propylene-based polymer obtained or obtainable by a process as described herein, comprising contacting propylene or a mixture of propylene and ethylene with a catalyst system according to the present invention.

In one embodiment the present invention relates to the production of a homopolymer of polypropylene. Several polymer properties are discussed here.

Xylene soluble fraction (XS) is preferably from about 0.5 wt % to about 10 wt %, or from about 1 wt % to about 8 wt %, or from 2 to 6 wt %, or from about 1 wt % to about 5 wt %. Preferably, the xylene amount (XS) is lower than 6 wt %, preferably lower than 5 wt %, more preferably lower than 4 wt % or even lower than 3 wt % and most preferably lower than 2.7 wt %.

The lump content is preferably below 10 wt %, preferably below 4 wt % and more preferably below 3 wt %.

The olefin polymer obtained in the present invention is considered to be a thermoplastic polymer. The thermoplastic polymer composition according to the invention may also contain one or more of usual additives, like those mentioned above, including stabilisers, e.g. heat stabilisers, anti-oxidants, UV stabilizers; colorants, like pigments and dyes; clarifiers; surface tension modifiers; lubricants; flame-retardants; mould-release agents; flow improving agents; plasticizers; anti-static agents; impact modifiers; blowing agents; fillers and reinforcing agents; and/or components that enhance interfacial bonding between polymer and filler, such as a maleated polypropylene, in case the thermoplastic polymer is a polypropylene composition. The skilled person can readily select any suitable combination of additives and additive amounts without undue experimentation.

The amount of additives depends on their type and function; typically is of from 0 to about 30 wt %; preferably of from 0 to about 20 wt %; more preferably of from 0 to about 10 wt % and most preferably of from 0 to about 5 wt % based on the total composition. The sum of all components added in a process to form the polyolefins, preferably the propylene-base polymers or compositions thereof should add up to 100 wt %.

The thermoplastic polymer composition of the invention may be obtained by mixing one or more of the thermoplastic polymers with one or more additives by using any suitable means. Preferably, the thermoplastic polymer composition of the invention is made in a form that allows easy processing into a shaped article in a subsequent step, like in pellet or granular form. The composition can be a mixture of different particles or pellets; like a blend of a thermoplastic polymer and a master batch of nucleating agent composition, or a blend of pellets of a thermoplastic polymer comprising one of the two nucleating agents and a particulate comprising the other nucleating agent, possibly pellets of a thermoplastic polymer comprising said other nucleating agent. Preferably, the thermoplastic polymer composition of the invention is in pellet or granular form as obtained by mixing all components in an apparatus like an extruder; the advantage being a composition with homogeneous and well-defined concentrations of the nucleating agents (and other components).

The invention also relates to the use of the polyolefins, preferably the propylene-based polymers (also called polypropylenes) according to the invention in injection moulding, blow moulding, extrusion moulding, compression moulding, casting, thin-walled injection moulding, etc. for example in food contact applications.

Furthermore, the invention relates to a shaped article comprising the polyolefin, preferably the propylene-based polymer according to the present invention.

The polyolefin, preferably the propylene-based polymer according to the present invention may be transformed into shaped (semi)-finished articles using a variety of processing techniques. Examples of suitable processing techniques include injection moulding, injection compression moulding, thin wall injection moulding, extrusion, and extrusion compression moulding. Injection moulding is widely used to produce articles such as for example caps and closures, batteries, pails, containers, automotive exterior parts like bumpers, automotive interior parts like instrument panels, or automotive parts under the bonnet. Extrusion is for example widely used to produce articles, such as rods, sheets, films and pipes. Thin wall injection moulding may for example be used to make thin wall packaging applications both for food and non-food segments. This includes pails and containers and yellow fats/margarine tubs and dairy cups.

The present invention further relates to the use of a monoester and a compound represented by Formula A, for example a Fischer projection of Formula A, as an internal electron donor in a procatalyst for polymerization of olefins. Polyolefins with improved properties, e.g. having broad molecular weight distribution and high isotacticity are produced with using a monoester as activator and the compound represented by Formula A, for example a Fischer projection of Formula A, as internal electron donor in a Ziegler-Natta procatalyst.

It is noted that the invention relates to all possible combinations of features recited in the claims. Features described in the description may further be combined.

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, preferred in particular are those combinations of features that are present in the claims.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention will be further elucidated with the following examples without being limited hereto.

### EXAMPLES

The performance of a procatalyst prepared using a butyl Grignard support, a monoester as activator and an amidobenzoate as internal donor.

First, the preparation of a specific amidobenzoate (AB) is disclosed below.

### Preparation of 4-[benzoyl(methyl)amino]pentan-yl benzoate (AB)

### Step a)

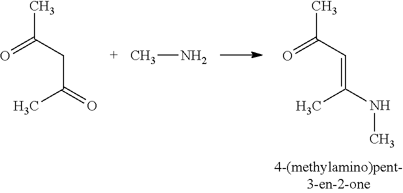

40% monomethylamine solution in water (48.5 g, 0.625 mol) was added drop wise to a stirred solution of substituted pentane-2,4-dione (50 g, 0.5 mol) in toluene (150 ml. After the addition, the reaction mass was stirred at room temperature for 3 hours and then refluxed. During the reflux the water formed was azeotropically removed using a Dean-stark trap. Then the solvent was removed under reduced pressure to give 4-(methylamino)pent-3-en-2-one, 53.5 g (95% yield), which was then directly used for reduction.

### Step b)

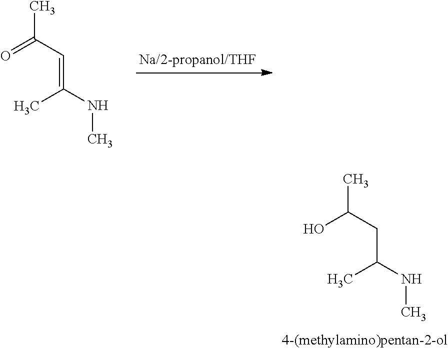

4-(methylamino)-pent-3-en-2-one (100 g) was added to a stirred mixture of 1000 ml 2-propanol and 300 ml toluene. To this solution, small piece of metallic sodium 132 g was gradually added at a temperature of from 25 to 60° C. The reaction mass was refluxed for 18 h. The mass was cooled to room temperature and was poured in cold water and extracted with dichloromethane. The extract was dried over sodium sulfate, filtered and then evaporated under reduced pressure to give 65 g 4-(methylamino)pentan-2-ol (isomer mixture) oil (63% yield).

### Step c)

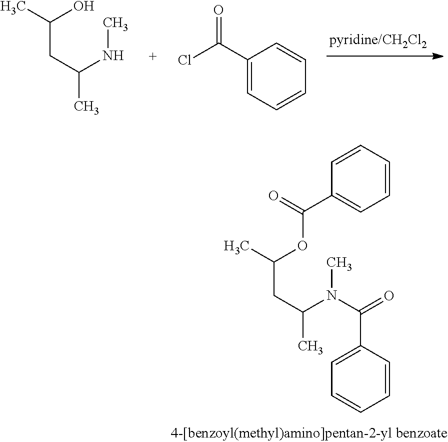

4-(methylamino)pentan-2-ol (10 g) was added to a mixture of pyridine (16.8 g) and toluene (100 ml). The mass was cooled to 10° C. and benzoyl chloride (24 g) was added drop wise. The mixture was refluxed for 6 h. The mixture was then diluted with toluene and water. The organic layer was washed with diluted HCl, water saturated bicarbonate and brine solution. The organic layer was dried over sodium sulfate, filtered and then evaporated under reduced pressure. The residue was purified by flash chromatography to form 25 g product as thick oil (90% yield). The product was characterized by ¹H NMR and ¹³C NMR: ¹H NMR (300 MHz, CDCl₃) δ=7.95-7.91 (m, 1H), 7.66-7.60 (m, 2H), 7.40-7.03 (m, 5H), 6.78-6.76 (m, 2H), 4.74-5.06 (br m, 1H), 3.91-3.82 (m, 1H), 2.83-2.56 (ddd, 3H), 2.02-1.51 (m, 1H), 1.34-1.25 (dd, 1H), 1.13-1.02 (m, 6H); ¹³C NMR (75 MHz, CDCl₃), δ=170.9, 170.4, 170.3, 164.9, 164.6, 135.9, 135.8, 135.2, 131.8, 131.7, 131.6, 129.6, 129.4, 129.3, 128.9, 128.4, 128.3, 128.2, 128.0, 127.7, 127.3, 127.2, 127.1, 127.0, 125.7, 125.6, 125.0, 124.9, 68.3, 67.5, 67.3, 49.8, 49.4, 44.9, 44.4, 39.7, 39.0, 38.4, 38.3, 30.5, 29.8, 25.5, 25.1, 19.33, 19.1, 18.9, 18.3, 17.0, 16.8, 16.7.

m/z=326.4 (m+1)

The ¹H-NMR and ¹³C-NMR spectra are recorded on a Varian Mercury-300 MHz NMR Spectrometer, using deuterated chloroform as a solvent.

In the Examples below a procatalyst is prepared using the following phases:
Phase A) preparation of solid support;
Phase B) activating said solid support;
Phase C) contacting said activated solid support with a titanium catalytic species, an ethylbenzoate monoester activator, and a amidobenzoate internal donor.

During stage I of phase C said activated solid support was first contacted with titanium tetrahalide and an ethylbenzoate activator (in a EB/Mg molar ratio of 0.15). During stage II of phase C the intermediate product obtained from stage I was contacted with additional titanium tetrahalide and an amidobenzoate internal donor (in a AB/Mg molar ratio of 0.04). During stage II of phase C the intermediate product obtained from stage II was contacted with additional titanium tetrahalide to obtain the procatalyst.

### Preparation of Procatalysts According to the Present Invention

The several different phases and stages for the preparation of the procatalyst are discussed below.

### Example 1: Preparation of a Procatalyst on an Activated Butyl-Grignard Support

Preparation of Grignard Reagent (Step o))—Phase A

This step o) constitutes the first part of phase A of the process for preparation of the procatalyst.

A stirred flask, fitted with a reflux condenser and a funnel, was filled with magnesium powder (24.3 g). The flask was brought under nitrogen. The magnesium was heated at 80° C. for 1 hour, after which dibutyl ether (150 ml), iodine (0.03 g) and n-chlorobutane (4 ml) were successively added. After the colour of the iodine had disappeared, the temperature was raised to 80° C. and a mixture of n-chlorobutane (110 ml) and dibutyl ether (750 ml) was slowly added for 2.5 hours. The reaction mixture was stirred for another 3 hours at 80° C. Then the stirring and heating were stopped and the small amount of solid material was allowed to settle for 24 hours. By decanting the colourless solution above the precipitate, a solution of butylmagnesiumchloride with a concentration of 1.0 mol Mg/I was obtained.

Preparation of Solid Magnesium Compound (Step i))—Phase A

This step i) constitutes the second part of phase A of the process for preparation of the procatalyst.

This step is carried out as described in Example XX of EP 1 222 214 B1, except that the dosing temperature of the reactor is 35° C., the dosing time is 360 min and the propeller stirrer w is as used. An amount of 250 ml of dibutyl ether is introduced to a 1 liter reactor. The reactor is fitted by propeller stirrer and two baffles. The reactor is thermostated at 35° C.

The solution of reaction product of step A (360 ml, 0.468 mol Mg) and 180 ml of a solution of tetraethoxysilane (TES) in dibutyl ether (DBE), (55 ml of TES and 125 ml of DBE), are cooled to 10° C., and then are dosed simultaneously to a mixing device of 0.45 ml volume supplied with a stirrer and jacket. Dosing time is 360 min. Thereafter the premixed reaction product A and the TES-solution are introduced to a reactor. The mixing device (minimixer) is cooled to 10° C. by means of cold water circulating in the minimixer's jacket. The stirring speed in the minimixer is 1000 rpm. The stirring speed in reactor is 350 rpm at the beginning of dosing and is gradually increased up to 600 rpm at the end of dosing stage.

On the dosing completion the reaction mixture is heated up to 60° C. and kept at this temperature for 1 hour. Then the stirring is stopped and the solid substance is allowed to settle. The supernatant is removed by decanting. The solid substance is washed three times using 500 ml of heptane. As a result, a pale yellow solid substance, reaction product B (the solid first intermediate reaction product; the support), is obtained, suspended in 200 ml of heptane. The average particle size of support is 22 μm and span value (d₉₀−d₁₀)/d₅₀=0.5.

Activation of First Intermediate Reaction Product (Step ii))—Phase B

This step ii) constitutes phase B of the process for preparation of the procatalyst as discussed above.

Support activation was carried out as described in Example IV of WO/2007/134851 to obtain the second intermediate reaction product.

In inert nitrogen atmosphere at 20° C. a 250 ml glass flask equipped with a mechanical agitator is filled with slurry of 5 g of reaction product B dispersed in 60 ml of heptane. Subsequently a solution of 0.22 ml ethanol (EtOH/Mg=0.1) in 20 ml heptane is dosed under stirring during 1 hour. After keeping the reaction mixture at 20° C. for 30 minutes, a solution of 0.79 ml titanium tetraethoxide (TET/Mg=0.1) in 20 ml of heptane was added for 1 hour.

The slurry was slowly allowed to warm up to 30° C. for 90 min and kept at that temperature for another 2 hours. Finally the supernatant liquid is decanted from the solid reaction product (the second intermediate reaction product; activated support) which was washed once with 90 ml of heptane at 30° C.

The activated support, according to chemical analysis, comprises a magnesium content of 17.3 wt. %, a titanium content of 2.85 wt. %, and a chloride content of 27.1 wt. % corresponding to a molar ratio of CI/Mg of 1.07 and Ti/Mg of 0.084.

### Preparation of Procatalyst—Phase C

This constitutes phase C of the process for preparation of the procatalyst as discussed above.

A reactor is brought under nitrogen and 125 ml of titanium tetrachloride is added to it. The reactor is heated to 100° C. and a suspension, containing about 5.5 g of activated support (step C) in 15 ml of heptane, is added to it under stirring. The reaction mixture is kept at 110° C. for 10 min.

Then ethyl benzoate (EB/Mg=0.25 mol) is added in 2 ml of chlorobenzene. The reaction mixture is kept for 60 min at 110° C. Then the stirring is stopped and the solid substance is allowed to settle. The supernatant is removed by decanting, after which the solid product is washed with chlorobenzene (125 ml) at 100° C. for 20 min. Then the washing solution is removed by decanting. This concludes stage I of Phase C.

Then a mixture of titanium tetrachloride (62.5 ml) and chlorobenzene (62.5 ml) is added. The temperature of reaction mixture is increased to 115° C. and stirred for 30 minutes. Then the stirring was stopped and the solid substance is allowed to settle.

Then a mixture of titanium tetrachloride (62.5 ml) and chlorobenzene (62.5 ml) is added. The temperature of reaction mixture is increased to 115° C. and 4-[benzoyl(methyl)amino]pentan-2-yl benzoate (aminobenzoate, AB, AB/Mg=0.15 mol) in 2 ml of chlorobenzene is added to reactor. Then the reaction mixture is kept at 115° C. for 30 min. After which the stirring was stopped and the solid substance is allowed to settle. The supernatant was removed by decanting. This concludes stage II of Phase C.

Then a mixture of titanium tetrachloride (62.5 ml) and chlorobenzene (62.5 ml) is added. The reaction mixture is kept at 115° C. for 30 min, after which the solid substance is allowed to settle. The supernatant is removed by decanting and the solid is washed five times using 150 ml of heptane at 60° C., after which the catalyst component, suspended in heptane, is obtained. This concludes stage III of Phase C. The resulting procatalyst has a titanium content of 2.6 wt. %.

### Example 2: Preparation of a Procatalyst on a Double Activated Butyl-Grignard Support

Example 1 was repeated but in addition to the activation phase B), an activation using methanol was carried out as follows:

Under an inert nitrogen atmosphere at 20° C. a 250 ml glass flask equipped with a mechanical agitator was filled with a slurry of 5 g of the reaction product of step ii) dispersed in 60 ml of heptane. Subsequently a solution of 0.86 ml methanol (MeOH/Mg=0.5 mol) in 20 ml heptane was dosed under stirring during 1 hour. After keeping the reaction mixture at 20° C. for 30 minutes the slurry was slowly allowed to warm up to 30° C. for 30 min and kept at that temperature for another 2 hours. Finally the supernatant liquid was decanted from the solid reaction product which was washed once with 90 ml of heptane at 30° C. The molar ratio of MeOH/Mg was 0.2. The resulting procatalyst has a titanium content of 3.2 wt. %.

### Example 3: Preparation of a Procatalyst on a Double Activated Butyl-Grignard Support

Example 3 was repeated but the molar ratio of MeOH/Mg is 0.4. The resulting procatalyst has a titanium content of 3.5 wt. %.

### Example 4: Preparation of a Procatalyst on an Activated Butyl-Grignard Support

Example 3 was repeated but the molar ratio of MeOH/Mg is 0.3. The resulting procatalyst has a titanium content of 3.3 wt. %.

### Preparation of Homopolymer of Propylene

Polymerization of propylene is carried out in a stainless steel reactor (with a volume of 0.7 I) in heptane (300 ml) at a temperature of 70° C., total pressure 0.7 MPa and hydrogen presence (55 ml) for 1 hour in the presence of a catalyst system comprising the procatalyst according to step D, triethylaluminium as co-catalyst and n-propyltrimethoxysilane as external donor. The concentration of the procatalyst is 0.033 g/l; the concentration of triethylaluminium is 4.0 mmol/l; the concentration of n-propyltrimethoxysilane was 0.2 mmol/l. The results are shown in Table 1 below.

TABLE 1

| Ex. # | EB/Mg | AB/Mg | MeOH/Mg | Ti. Wt. % | PP yield | APP | MFR | BD |
|---|---|---|---|---|---|---|---|---|
| 1 | 0.15 | 0.04 | n.a. | 2.6 | 5.7 | 0.9 | 2.3 | 434 |
| 1 | 0.15 | 0.04 | 0.2 | 3.2 | 6.8 | 0.9 | 2.3 | 450 |
| 2 | 0.15 | 0.04 | 0.4 | 3.5 | 8.9 | 0.8 | 3.6 | 453 |
| 3 | 0.15 | 0.04 | 0.3 | 3.3 | 8.0 | 1.0 | 2.4 | 473 |

The results from Table 1 clearly show that using the method according to the present invention propylene homopolymers can be obtained having good yield, APP, MFR and BD. It is noted that the additional activation using methanol leads to a higher yield.

### Semi-Continuous Preparation Ethylene-Propylene Copolymer Rubber

Gas-phase polymerizations were performed in a set of two horizontal, cylindrical reactors in series, wherein a propylene homopolymer was formed in the first reactor and an ethylene-propylene copolymer rubber in the second one to prepare an impact copolymer. The first reactor was operated in a continuous way, the second one in a batch manner. In the synthesis of the homopolymer, the polymer was charged into the secondary reactor blanketed with nitrogen. The first reactor was equipped with an off-gas port for recycling reactor gas through a condenser and back through a recycle line to the nozzles in the reactor. Both reactors had a volume of one gallon (3.8-liter) measuring 10 cm in diameter and 30 cm in length. In the first reactor liquid propylene was used as the quench liquid; for the synthesis of copolymers the temperature in the second reactor was kept constant by a cooling jacket. The procatalyst (having a molar ratio of EB/Mg of 0.15 and a molar ratio of AB/Mg of 0.04) was introduced into the first reactor as a 5-7 weight percent slurry in hexane through a liquid propylene-flushed catalyst addition nozzle. External donor (DiPDMS: di-isopropyl dimethoxy silane) and TEAl in hexane were fed to the first reactor through a different liquid propylene flushed addition nozzle. For the production of copolymer, an AI/Ti molar ratio of 160 and Si/Ti molar ratio of 11.3 was used. Moreover, the procatalyst is also activated with methanol as discussed above having a MeOH/Mg molar ratio of 0.3.

During operation, polypropylene powder produced in the first reactor passed over a weir and was discharged through a powder discharge system into the second reactor. The polymer bed in each reactor was agitated by paddles attached to a longitudinal shaft within the reactor that was rotated at about 50 rpm in the first and at about 75 rpm in the second reactor. The reactor temperature and pressure were maintained at 61° C. and 2.2 MPa in the first and for the copolymer synthesis at 66° C. and 2.2 MPa in the second reactor. The production rate was about 200-250 g/h in the first reactor in order to obtain a stable process.

For the homopolymer synthesis the hydrogen concentration in the off gas was controlled such to achieve the targeted melt flow rate (MFR). For the copolymer synthesis, hydrogen was fed to the reactor to control a melt flow rate ratio over the homopolymer powder and copolymer powder. The composition of the ethylene-propylene copolymer (RCC2) was controlled by adjusting the ratio ethylene and propylene (C2/C3) in the recycling gas in the second reactor based on gas chromatography analysis.

Examples 5-8 show different runs for this copolymerization using different H₂/C3 and different C2/C3 ratios. The results are shown in Table 2 below:

TABLE 2

| Ex. # | H2/C3 | C2/C3 | Yield | MFR | RC | RCC2 |
|---|---|---|---|---|---|---|
| 5 | 0.0685 | 0.8217 | 16.1 | 17.69 | 28.68 | 60.31 |
| 6 | 0.0668 | 0.795 | 16.5 | 17.69 | 29.44 | 61.32 |
| 7 | 0.0699 | 0.6561 | 17.3 | 16.83 | 37.6 | 54.86 |
| 8 | 0.0704 | 0.6636 | 17.2 | 22.31 | 34.51 | 54.71 |

From Table 2 can be observed that a so-called impact copolymer can be obtained having desired properties using the method according to the present invention and that the properties can be tuned by selecting the appropriate reaction conditions.

Abbreviations and measuring methods:
yield, in kg/g cat is the amount of polypropylene obtained per gram of catalyst component.
APP, in wt. % is the weight percentage of atactic polypropylene. Atactic PP is the PP fraction soluble in heptane during polymerization. APP was determined as follows: 100 ml of the filtrate (y ml) obtained in separating the polypropylene powder (x g) and the heptane was dried over a steam bath and then under vacuum at 60° C. That yielded z g of atactic PP. The total amount of Atactic PP (q g) is: (y/100)*z. The weight percentage of Atactic PP is: (q/(q+x))*100%.
XS, wt % is xylene solubles, measured according to ASTM D 5492-10.
MFR or melt flow rate in dg/min is measured at 230° C. with 2.16 kg load, measured according to ISO 1133:2005.
Mw/Mn: Polymer molecular weight and its distribution (MWD) were determined by Waters 150° C. gel permeation chromatograph combined with a Viscotek 100 differential viscosimeter. The chromatograms were run at 140° C. using 1,2,4-trichlorobenzene as a solvent with a flow rate of 1 ml/min. The refractive index detector was used to collect the signal for molecular weights.
The ¹H-NMR and ¹³C-NMR spectra were recorded on a Varian Mercury-300 MHz NMR Spectrometer, using deuterated chloroform as a solvent.
bulk density or BD in g/I means the weight per unit volume of a material; it is measured as apparent density according to ASTM D1895-96 Reapproved 2010-e1, test method A.
C₂/C₃ is the molar ratio of ethylene to propylene in the gas cap of the reactor, measured by on-line gas chromatography.
Al/Ti is the molar ratio of aluminium (of the co-catalyst) to titanium (of the procatalyst) added to the reactor.
Si/Ti is the molar ratio of silicon (of the external donor) to titanium (of the procatalyst) to the reactor.
H₂/C₃ is the molar ratio of hydrogen to propylene in the gas cap of the reactor, measured by on-line gas chromatography.
RC in wt. % is the amount of rubber incorporated in the copolymer (weight percent); measured with IR spectroscopy, which was calibrated using ¹³C-NMR according to known procedures.
RCC2 in wt. % is the amount of ethylene incorporated in the rubber fraction (weight percent); measured with IR spectroscopy, which was calibrated using ¹³C-NMR according to known procedures

1. A process for preparing a procatalyst for polymerization of olefins, comprising contacting a magnesium-containing support with a halogen-containing titanium compound, a monoester, a first internal electron donor, wherein the internal electron donor is represented by a compound represented by Formula A, for example a Fischer projection of Formula A, and optionally a second internal electron donor selected from a group consisting of diesters and diethers, 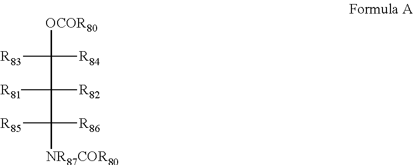
Wherein in Formula A:
each R⁸⁰ group is independently a substituted or unsubstituted aromatic group having from 6 to 20 carbon atoms;
R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof;
R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof;
N is nitrogen atom; O is oxygen atom; and C is carbon atom; said process comprising the steps of:
i) contacting a compound R⁴_{z}MgX⁴_{2-z} with an alkoxy- or aryloxy-containing silane compound to give a first intermediate reaction product, being a solid Mg(OR)ₓX¹₂₋ₓ, wherein: R¹ is a linear, branched or cyclic hydrocarbyl group independently selected from alkyl, alkenyl, aryl, aralkyl, alkoxycarbonyl or alkylaryl groups, and one or more combinations thereof, wherein said hydrocarbyl group may be substituted or unsubstituted, may contain one or more heteroatoms; wherein R⁴ is butyl; wherein X⁴ and X¹ are each independently selected from the group of consisting of fluoride (F−), chloride (Cl−), bromide (Br−) or iodide (I−); z is in a range of larger than 0 and smaller than 2, being 0<z<2;
ii) optionally contacting the solid Mg(OR)ₓX¹₂₋ₓ obtained in step ii) with at least one activating compound selected from the group formed by activating electron donors and metal alkoxide compounds of formula M¹(OR²)_{v-w}(OR³)_{w} or M²(OR²)_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R² and R³ are each a linear, branched or cyclic hydrocarbyl group independently selected from alkyl, alkenyl, aryl, aralkyl, alkoxycarbonyl or alkylaryl groups, and one or more combinations thereof, wherein said hydrocarbyl group may be substituted or unsubstituted, may contain one or more heteroatoms; wherein w is smaller than v;
iii) contacting the first or second intermediate reaction product, obtained respectively in step i) or ii), with a halogen-containing Ti-compound, the monoester, and said internal electron represented by a compound represented by Formula A, for example a Fischer projection of Formula A, as the first internal electron donor, and optionally the diester or diether as the second internal electron donor.

2. The process according to claim 1, wherein R⁸¹, R⁸², R⁸³, R⁸⁴, R⁸⁵, and R⁸⁶ are independently selected from a group consisting of hydrogen, C₁-C₁₀ straight and branched alkyl; C₃-C₁₀ cycloalkyl; C₆-C₁₀ aryl; and C₇-C₁₀ alkaryl and aralkyl group; C₃-C₁₀ cycloalkyl; C₆-C₁₀ aryl; and C₇-C₁₀ alkaryl and aralkyl group.

3. The process according to claim 1, wherein R⁸⁷ is selected from a group consisting of methyl, ethyl, propyl, isopropyl, butyl, tert-butyl, phenyl, benzyl, substituted benzyl and halophenyl group.

4. The process according to claim 1, wherein R⁸⁰ is selected from the group consisting of C₆-C₁₀ aryl; and C₇-C₁₀ alkaryl and aralkyl group.

5. The process according to claim 1, wherein the monoester is an acetate or a benzoate.

6. The process according to claim 1, wherein the internal electron donor is selected from the group consisting of 4-[benzoyl(methyl)amino]pentan-2-yl benzoate; 2,2,6,6-tetramethyl-5-(methylamino)heptan-3-ol dibenzoate; 4-[benzoyl (ethyl)amino]pentan-2-yl benzoate and 4-(methylamino)pentan-2-yl bis (4-methoxy)benzoate).

7. The process according to claim 1, further comprising an additional or second internal electron donor selected from the group consisting of diesters and diethers.

8. The process according to claim 1, wherein as internal donor 4-[benzoyl(methyl)amino]pentan-2-yl benzoate is used and as monoester ethyl benzoate is used.

9. The process according to claim 1, wherein as internal donor 4-[benzoyl(methyl)amino]pentan-2-yl benzoate is used and as monoester ethyl benzoate is used and as second internal electron donor dibutyl phthalate is used.

10. The process according to claim 1, wherein as internal donor 4-[benzoyl(methyl)amino]pentan-2-yl benzoate is used and as monoester ethyl benzoate is used and as second internal electron donor 9,9-bis-methoxymethyl-fluorene is used.

11. A pro catalyst obtainable by the process according to claim 1.

12. A polymerization catalyst system comprising the procatalyst according to claim 11, a co-catalyst and optionally an external electron donor.

13. A process of making a polyolefin by contacting at least one olefin with the catalyst system according to claim 12.

14. A polyolefin obtainable by the process according to claim 13.

15. A shaped article, comprising the polyolefin according to claim 14.

16. The process according to claim 1, wherein R⁸¹, R⁸², R⁸³, R⁸⁴, R⁸⁵, and R⁸⁶ are each independently selected from hydrogen or a linear, branched or cyclic hydrocarbyl group, selected from alkyl, alkenyl, aryl, aralkyl, alkoxycarbonyl or alkylaryl groups, and one or more combinations thereof having from 1 to 20 carbon atoms; and
R⁸⁷ is a hydrogen or a linear, branched or cyclic hydrocarbyl group, selected from alkyl, alkenyl, aryl, aralkyl, alkoxycarbonyl or alkylaryl groups, and one or more combinations thereof, having from 1 to 20 carbon atoms.

17. The process according to claim 16, wherein R⁸¹ and R⁸² is each a hydrogen atom and R⁸³, R⁸⁴, R⁸⁵, and R⁸⁶ are independently selected from a group consisting of methyl, ethyl, propyl, isopropyl, butyl, tert-butyl, and phenyl group.

18. The process according to claim 17, wherein when one of R⁸³ and R⁸⁴ and one of R⁸⁵ and R⁸⁶ has at least one carbon atom, then the other one of R⁸³ and R⁸⁴ and of R⁸⁵ and R⁸⁶ is each a hydrogen atom.
